(19) United States
(12) Patent Application Publication
(10) Pub. No.: US 2022/0207485 A1
(43) Pub. Date: Jun. 30, 2022

(54) SYSTEMS AND METHODS FOR ASSISTING IN MANAGING TEAMS

(71) Applicant: TECHNEHIRE, INC., San Jose, CA (US)

(72) Inventors: Carol HANSEN, San Jose, CA (US); Enam ul HAQUE, Richardson, TX (US); Jawwad UH-HAQUE, Boise, ID (US)

(21) Appl. No.: 17/566,831

(22) Filed: Dec. 31, 2021

Related U.S. Application Data
(60) Provisional application No. 63/132,802, filed on Dec. 31, 2020.

(51) Int. Cl. G06Q 10/10

(52) U.S. Cl. CPC G06Q 10/1053; G06F 40/174

(57) ABSTRACT

Systems and methods for assisting in managing teams are provided herein. In some aspects, contemplated systems and methods obtain, build upon, and/or utilize individual workplace preferences, skills and/or attributes (e.g., candidate, employee, manager) and team-based needs and/or preferences in creating and managing teams.

### CROSS-REFERENCE TO RELATED APPLICATION

This application claims priority to U.S. patent application No. 63/132,802, filed on Dec. 31, 2020. These and all other extrinsic materials discussed herein, including publications, patent applications, and patents, are incorporated by reference in their entirety. Where a definition or use of a term in an incorporated reference is inconsistent or contrary to the definition of that term provided herein, the definition of that term provided herein applies and the definition of the term in the reference does not apply.

### FIELD OF THE INVENTION

The present invention relates to human resources and team management, and provides systems and methods for assisting in managing and building high-functioning teams.

### BACKGROUND

Companies invest heavily in recruiting and human resources management. Some efforts have been made to combine certain HR functions, such as managing payroll, benefits administration, and tracking an employee's training records, manager reviews, or completed tasks.

### SUMMARY OF THE INVENTION

The disclosure herein provides systems and methods that are advantageous over known human resources management systems, and which obtains, builds upon, and/or utilizes individual preferences, skills and/or attributes (e.g., candidate, employee, manager) and team-based needs and/or preferences in creating and managing teams.

In some aspects, a system for assisting in managing teams is provided, comprising: one or more processors; one or more databases in communication with the one or more processors and configured to store team profiles comprising a first team profile, a second team profile, and a third team profile, and wherein each team profile comprises team positions associated with at least one of preferred skills, preferred attributes, and preferred workplace preferences; and a memory storing software instructions that, when executed by the one or more processors, cause the one or more processors to: present, via a first team interface, a first review form associated with a first team and a first team profile; receive a first set of review data corresponding to the first team, the first team profile and the first review form; present, via a second team interface, a second review form associated a second team and a second team profile; receive a second set of review data corresponding to the second team, the second team profile and the second review form; determine a preferred skill, a preferred attribute, and a preferred workplace preference associated with a high performing team position of a third team profile based at least in part on the first set of review data and the second set of review data; modify the third team profile based on determining the preferred skill, the preferred attribute, and the preferred workplace preference associated with the high performing team position of the third team profile; and store the modified third team profile in the one or more databases.

It should be appreciated that a workstyle preference can be determined based on an assessment in which

As used herein, the term “workstyle preferences” or “workplace preferences” can refer to a mindset type or workplace behavioral style determined based at least in part on an assessment of a candidate's (e.g., employee, job seeker, manager, team member) attributes and/or candidate's views on certain attributes. In some aspects, candidate's workplace preferences can be assessed by, for example, presenting question pairs that are statements relating to workplace preferences with assigned attributes and/or other workplace attributes/traits, and asking the candidate to choose which best describes the candidate and/or the position. Exemplary attributes can comprise, among other things, what excites the candidate, what makes the candidate feel a sense of accomplishment, whether the candidate prefers to work independently or with teammates, whether the candidate has a desire for leadership, how extroverted or introverted a candidate is, how content the candidate is, what causes the candidate anxiety, how the candidate performs under pressure, honesty, trustworthiness, creativity, integrity, dependability, communication style, adaptability, organization, willingness to learn, empathy, etc. Based at least in part on the user's selections between question pairs as to what statement the candidate states more accurately reflects the candidate in the workplace, the candidate's workstyle preferences can be determined (e.g., are they a leader, subject matter expert, evangelist, and/or team spirit). In some aspects, the candidate's attributes can be determined in any suitable matter, for example, using any suitable assessment, which can comprise multiple choice questions, true/false questions, questions requiring matching, short answers, and/or essays, and/or any other questions in any suitable form (e.g., oral, computational).

As used herein, the term “hard skills” refers to talents and abilities that can be measured and/or technical knowledge or training a candidate has gained through experience (e.g., bilingual or multilingual, degrees and certifications, expertise in certain fields, etc.).

In some aspects, the first, second and third teams comprise three different teams. In some aspects, the first, second and third teams are in three different departments. In some aspects, the first, second and third teams are in three different locations. In some aspects, the first, second and third teams are teams of different companies. In some aspects, the first and second teams have a common team member.

Also provided herein is a computer implemented method for assisting in managing teams, comprising: presenting, via a first team interface, a first review form associated with a first team and a first team profile; receiving a first set of review data corresponding to the first team, the first team profile and the first review form; presenting, via a second team interface, a second review form associated a second team and a second team profile; receiving a second set of review data corresponding to the second team, the second team profile and the second review form; determining a preferred skill, a preferred attribute, and a preferred workplace preference associated with a high performing team position of a third team profile based at least in part on the first set of review data and the second set of review data; modifying the third team profile based on determining the preferred skill, the preferred attribute, and the preferred workplace preference associated with the high performing team position of the third team profile; and storing the modified third team profile in one or more databases. The one or more databases can be configured to store team profiles comprising the first team profile, the second team profile, and the third team profile, and wherein each team profile comprises team positions associated with at least one of preferred skills, preferred attributes, and preferred workplace preferences.

In some aspects, the first, second and third teams comprise three different teams. In some aspects, the first, second and third teams are in three different departments. In some aspects, the first, second and third teams are in three different locations. In some aspects, the first, second and third teams are teams of different companies. In some aspects, the first and second teams have a common team member.

Also provided herein is a non-transitory computer-readable medium or media having computer-readable instructions stored thereon that are executable by a processor to: present, via a first team interface, a first review form associated with a first team and a first team profile; receive a first set of review data corresponding to the first team, the first team profile and the first review form; present, via a second team interface, a second review form associated a second team and a second team profile; receive a second set of review data corresponding to the second team, the second team profile and the second review form; determine a preferred skill, a preferred attribute, and a preferred workplace preference associated with a high performing team position of a third team profile based at least in part on the first set of review data and the second set of review data; modify the third team profile based on determining the preferred skill, the preferred attribute, and the preferred workplace preference associated with the high performing team position of the third team profile; and store the modified third team profile in one or more databases. The one or more databases can be configured to store team profiles comprising the first team profile, the second team profile, and the third team profile, and wherein each team profile comprises team positions associated with at least one of preferred skills, preferred attributes, and preferred workplace preferences.

In some aspects, the first, second and third teams comprise three different teams. In some aspects, the first, second and third teams are in three different departments. In some aspects, the first, second and third teams are in three different locations. In some aspects, the first, second and third teams are teams of different companies. In some aspects, the first and second teams have a common team member.

Also provided herein is a system for assisting in managing teams, comprising: one or more processors; and a memory storing software instructions that, when executed by the one or more processors, cause the one or more processors to: obtain workplace preference data corresponding to a candidate; present, via a first user interface, a review form associated with the candidate; receive a first set of review data corresponding to the candidate and the review form; modify the review form based at least in part on the first set of review data; present, via a second user interface, the modified review form associated with the candidate; receive, a second set of review data corresponding to the candidate and the modified review form; assign the candidate to a first team based at least in part on the workplace preference data, and at least one of the first and second sets of review data.

In some aspects, assigning the candidate to the first team comprises removing the candidate from a second team.

In some aspects, the system further comprises one or more databases storing candidate profiles including a candidate profile comprising workplace preference data corresponding to the candidate, wherein the software instructions further cause the one or more processors to: modify the candidate profile associated with the candidate based at least in part on at least one of the first set of review data and the second set of review data; and store the modified candidate profile in the one or more databases.

In some aspects, the software instructions further cause the one or more processors to: assign a first weight to a first score corresponding to the first set of review data; assign a second weight to a second score corresponding to the second set of review data; and modify the candidate profile associated with the candidate based at least in part on at least one of the first and second scores.

In some aspects, the system further comprises one or more databases storing candidate profiles including a candidate profile comprising workplace preference data corresponding to the candidate, wherein the software instructions further cause the one or more processors to: store the modified candidate profile in the one or more databases.

In some aspects, the system further comprises one or more databases storing candidate profiles, candidate questions, candidate answers, and at least one of attributes and skills corresponding to each candidate answer of the candidate answers, wherein obtaining the workplace preference data comprises: presenting, via a candidate interface, a set of candidate questions from the one or more databases to a candidate; receiving, via the candidate interface, a set of candidate answers responding to a set of candidate questions; determining a set of attributes of the candidate based at least in part on the candidate answers and a query of the one or more databases; and determining a workplace preference of the candidate based at least in part on the set of attributes; and optionally store a candidate profile associated with the candidate and at least one of the workplace preference and the set of attributes in the one or more databases.

In some aspects, the software instructions further cause the one or more processors to: receive, via the candidate interface, a mask request; modify the candidate profile to mask at least one of a gender, a race, an ethnicity, an age, and a belief of the candidate based at least in part on the mask request; and present, via an employer interface, the modified candidate profile.

Also provided herein is a computer implemented method for assisting in managing teams, comprising: obtaining workplace preference data corresponding to a candidate; presenting, via a first user interface, a review form associated with the candidate; receiving a first set of review data corresponding to the candidate and the review form; modifying the review form based at least in part on the first set of review data; presenting, via a second user interface, the modified review form associated with the candidate; receiving, a second set of review data corresponding to the candidate and the modified review form; assigning the candidate to a first team based at least in part on the workplace preference data, and at least one of the first and second sets of review data.

In some aspects, assigning the candidate to the first team comprises removing the candidate from a second team.

In some aspects, the method further comprises modifying the candidate profile associated with the candidate based at least in part on at least one of the first set of review data and the second set of review data; and storing the modified candidate profile in one or more databases. The one or more databases can store candidate profiles including a candidate profile comprising workplace preference data corresponding to the candidate.

In some aspects, the method further comprises assigning a first weight to a first score corresponding to the first set of review data; assign a second weight to a second score corresponding to the second set of review data; and modifying the candidate profile associated with the candidate based at least in part on at least one of the first and second scores.

In some aspects, the method storing the modified candidate profile in one or more databases. The one or more databases can store candidate profiles including a candidate profile comprising workplace preference data corresponding to the candidate.

In some aspects, obtaining the workplace preference data comprises: presenting, via a candidate interface, a set of candidate questions from the one or more databases to a candidate; receiving, via the candidate interface, a set of candidate answers responding to a set of candidate questions; determining a set of attributes of the candidate based at least in part on the candidate answers and a query of the one or more databases; and determining a workplace preference of the candidate based at least in part on the set of attributes; and optionally storing a candidate profile associated with the candidate and at least one of the workplace preference and the set of attributes in one or more databases. The one or more databases can store candidate profiles, candidate questions, candidate answers, and at least one of attributes and skills corresponding to each candidate answer of the candidate answers.

In some aspects, the method further comprises: receiving, via the candidate interface, a mask request; modifying the candidate profile to mask at least one of a gender, a race, an ethnicity, an age, and a belief of the candidate based at least in part on the mask request; and presenting, via an employer interface, the modified candidate profile.

Also provided herein is a non-transitory computer-readable medium or media having computer-readable instructions stored thereon that are executable by a processor to: obtain workplace preference data corresponding to a candidate; present, via a first user interface, a review form associated with the candidate; receive a first set of review data corresponding to the candidate and the review form; modify the review form based at least in part on the first set of review data; present, via a second user interface, the modified review form associated with the candidate; receive, a second set of review data corresponding to the candidate and the modified review form; assign the candidate to a first team based at least in part on the workplace preference data, and at least one of the first and second sets of review data.

In some aspects, assigning the candidate to the first team comprises removing the candidate from a second team.

In some aspects, the computer-readable instructions are further executable by a processor to: modify the candidate profile associated with the candidate based at least in part on at least one of the first set of review data and the second set of review data; and store the modified candidate profile in one or more databases. The one or more databases can store review data, review forms and candidate profiles.

In some aspects, the computer-readable instructions are further executable by a processor to: assign a first weight to a first score corresponding to the first set of review data; assign a second weight to a second score corresponding to the second set of review data; and modify the candidate profile associated with the candidate based at least in part on at least one of the first and second scores.

In some aspects, the computer-readable instructions are further executable by a processor to: store the modified candidate profile in the one or more databases. The one or more databases can store review data, review forms and candidate profiles.

In some aspects, obtaining the workplace preference data comprises: presenting, via a candidate interface, a set of candidate questions from one or more databases to a candidate; receiving, via the candidate interface, a set of candidate answers responding to a set of candidate questions; determining a set of attributes of the candidate based at least in part on the candidate answers and a query of the one or more databases; and determining a workplace preference of the candidate based at least in part on the set of attributes; and optionally store a candidate profile associated with the candidate and at least one of the workplace preference and the set of attributes in the one or more databases. The one or more databases can store candidate profiles, candidate questions, candidate answers, and at least one of attributes and skills corresponding to each candidate answer of the candidate answers.

In some aspects, the computer-readable instructions are further executable by a processor to: receive, via the candidate interface, a mask request; modify the candidate profile to mask at least one of a gender, a race, an ethnicity, an age, and a belief of the candidate based at least in part on the mask request; and present, via an employer interface, the modified candidate profile.

Also provided herein is a system for assisting in managing teams, comprising: one or more processors; one or more databases in communication with the one or more processors and configured to store team profiles comprising team positions associated with at least one of preferred skills, preferred attributes, and preferred workplace preferences, and candidate profiles comprising candidates associated with at least one of acquired attributes, acquired skills, and acquired workplace preferences; a memory storing software instructions that, when executed by the one or more processors, cause the one or more processors to: obtain, via a first user interface, open position data associated with a team position; determine, via a query of the one or more databases, at least one of a preferred skill, a preferred attribute, and a preferred workplace preference associated with the team position; and obtain, via a query of the one or more databases, a result set of candidates recommended for an open position associated with the open position data, wherein each of the candidates of the result set of candidates is associated with at least one of an acquired attribute, an acquired skill, and an acquired workplace preference, wherein the at least one of the acquired attribute, the acquired skill, and the acquired workplace preference is associated with the at least one of the preferred skill, the preferred attribute, and the preferred workplace preference associated with the team position.

In some aspects, the result set of candidates comprises ranked candidates. In some aspects, the software instructions further cause the one or more processors to: receive, via a second user interface, placement data associated with a candidate of the result set of candidates being assigned to the open position; and modify a team profile associated with the team position based at least in part on the placement data.

Also provided herein is a computer implemented method, comprising: obtaining, via a first user interface, open position data associated with a team position; determining, via a query of one or more databases, at least one of a preferred skill, a preferred attribute, and a preferred workplace preference associated with the team position; and obtaining, via a query of the one or more databases, a result set of candidates recommended for an open position associated with the open position data, wherein each of the candidates of the result set of candidates is associated with at least one of an acquired attribute, an acquired skill, and an acquired workplace preference, wherein the at least one of the acquired attribute, the acquired skill, and the acquired workplace preference is associated with the at least one of the preferred skill, the preferred attribute, and the preferred workplace preference associated with the team position. The one or more databases can be configured to store team profiles comprising team positions associated with at least one of preferred skills, preferred attributes, and preferred workplace preferences, and candidate profiles comprising candidates associated with at least one of acquired attributes, acquired skills, and acquired workplace preferences.

In some aspects, the result set of candidates comprises ranked candidates. In some aspects, the method further comprises: receiving, via a second user interface, placement data associated with a candidate of the result set of candidates being assigned to the open position; and modifying a team profile associated with the team position based at least in part on the placement data.

Also provided herein is a non-transitory computer readable medium or media having computer-readable instructions stored thereon that are executable by a processor to: obtain, via a first user interface, open position data associated with a team position; determine, via a query of the one or more databases, at least one of a preferred skill, a preferred attribute, and a preferred workplace preference associated with the team position; and obtain, via a query of the one or more databases, a result set of candidates recommended for an open position associated with the open position data, wherein each of the candidates of the result set of candidates is associated with at least one of an acquired attribute, an acquired skill, and an acquired workplace preference, wherein the at least one of the acquired attribute, the acquired skill, and the acquired workplace preference is associated with the at least one of the preferred skill, the preferred attribute, and the preferred workplace preference associated with the team position.

In some aspects, the result set of candidates comprises ranked candidates. In some aspects, computer-readable instructions are further executable by a processor to: receive, via a second user interface, placement data associated with a candidate of the result set of candidates being assigned to the open position; and modify a team profile associated with the team position based at least in part on the placement data.

Also provided herein is a system for assisting in managing teams, comprising: one or more processors; and a memory storing software instructions that, when executed by the one or more processors, cause the one or more processors to: present, via a first user interface, a first review form associated with a candidate; present, via a second user interface, a second review form associated with the candidate; receive a first set of review data corresponding to the first review form and the candidate; receive a second set of review data corresponding to the second review form and the candidate; modify the first review form based at least in part on the first and second sets of review data; and present, via a third user interface, the modified first review form.

In some aspects, the first and second user interfaces are the same. In some aspects, the first and second review forms are the same. In some aspects, the first and second sets of review data are associated with a first reviewer.

Also provided herein is a computer-implemented method, comprising: presenting, via a first user interface, a first review form associated with a candidate; presenting, via a second user interface, a second review form associated with the candidate; receiving a first set of review data corresponding to the first review form and the candidate; receiving a second set of review data corresponding to the second review form and the candidate; modifying the first review form based at least in part on the first and second sets of review data; and presenting, via a third user interface, the modified first review form.

In some aspects, the first and second user interfaces are the same. In some aspects, the first and second review forms are the same. In some aspects, the first and second sets of review data are associated with a first reviewer.

Also provided herein is a non-transitory computer readable medium or media having computer-readable instructions stored thereon that are executable by a processor to: present, via a first user interface, a first review form associated with a candidate; present, via a second user interface, a second review form associated with the candidate; receive a first set of review data corresponding to the first review form and the candidate; receive a second set of review data corresponding to the second review form and the candidate; modify the first review form based at least in part on the first and second sets of review data; and present, via a third user interface, the modified first review form.

In some aspects, the first and second user interfaces are the same. In some aspects, the first and second review forms are the same. In some aspects, the first and second sets of review data are associated with a first reviewer.

Also provided herein is a system for assisting in managing teams, comprising: one or more processors; one or more databases in communication with the one or more processors and configured to store team profiles comprising a first team profile, a second team profile, and a third team profile, and wherein each team profile comprises team positions associated with at least one of preferred skills, preferred attributes, and preferred workplace preferences; and a memory storing software instructions that, when executed by the one or more processors, cause the one or more processors to: present, via a first team interface, a first review form associated with a first team and a first team profile; receive, via the first team interface, a first set of review data corresponding to the first team, the first team profile and the first review form; present, via a second team interface, a second review form associated with a second team and a second team profile; receive, via the second team interface, a second set of review data corresponding to the second team, the second team profile and the second review form; determine at least one of a preferred skill, a preferred attribute, and a preferred workplace preference associated with a high performing team position of a third team profile based at least in part on the first set of review data and the second set of review data; modify the third team profile based on determining the at least one of the preferred skill, the preferred attribute, and the preferred workplace preference associated with the high performing team position of the third team profile; store the modified third team profile in the one or more databases; and present, via a third team interface, the modified third team profile.

As one non-limiting example, it is contemplated that the first review form associated with the first team and the first team profile can comprise a high score (e.g., at least 7/10, at least 8/10, at least 9/10) and/or positive review related to one aspect of the team member's overall performance (e.g., a team member's quality of work product), and a low score (e.g., below or equal to 4/10, below or equal to 3/10, below or equal to 2/10) and/or negative review related to another aspect of the team member's overall performance (e.g., the team member's ability to work well with others). The second review form associated with the second team and the second team profile can comprise a high score and/or positive review related to one aspect of the team member's overall performance (e.g., a team member's quality of work product; how likely the reviewer is to request the team member being reviewed to be a part of its future team(s)), and a low score and/or negative review related to another aspect of the team member's overall performance (e.g., the team member's ability to work well with others). The system could determine that a low score and/or negative review related to one aspect of a team member's overall performance (e.g., the team member's ability to work well with others) has a high correlation (e.g., above a threshold of 50%) with a high score and/or positive review related to another aspect of the team member's overall performance (e.g., quality of work product). Based in whole or in part on this determination, the system could determine that a lack of ability to work well with others is a preferred/desirable attribute associated with a high performing team position (which can be the same or different type of team position) of an entirely different third team.

In some aspects, the first set of review data can compose an at least partially completed first review form, and the second review form can comprise the at least partially completed review form. In some aspects, the first set of review data can compose an at least partially completed review form, and the software instructions, when executed by the one or more processors, can cause the one or more processors to: (1) upon receiving the at least partially completed first review form, modify the first review form based at least in part on the first set of review data to at least one of: remove a question (e.g., based on determining answers relating to the question are not useful); add a question (e.g., based on determining additional information is needed in addition to an earlier question); replace a question (e.g., based on determining answers provided to a previous question are not useful, on-point, and/or complete); modify a question (e.g., based on determining answers provided to the pre-modified question are not useful, on-point, and/or complete); and pre-fill an answer (e.g., based on a previous answer(s) provided by the same and/or different reviewers). In some aspects, the second review form can comprise the modified review form.

In some aspects, the first set of review data can compose an at least partially completed first review form, and the software instructions, when executed by the one or more processors, can cause the one or more processors to: (1) upon receiving the at least partially completed first review form, modify the first review form based at least in part on the first set of review data to at least one of: remove a question (e.g., based on determining answers relating to the question are not useful); add a question (e.g., based on determining additional information is needed in addition to an earlier question); replace a question (e.g., based on determining answers provided to a previous question are not useful, on-point, and/or complete); modify a question (e.g., based on determining answers provided to the pre-modified question are not useful, on-point, and/or complete); and pre-fill an answer (e.g., based on a previous answer(s) provided by the same and/or different reviewers), and (2) present, via the first team interface, the modified first review form. In some aspects, the software instructions, when executed by the one or more processors, can further cause the one or more processors to: (3) receive, via the first team interface, a third set of review data corresponding to the first team, the first team profile, and the modified first review form; (4) calculate a first score of the first team based at least in part on the first set of review data and the third set of review data; and (5) modify the first team profile based at least in part on the first score (e.g., modify team members, modify workplace preferences, attributes, skills, etc. for example, based on determining the team now possesses a previously desired attribute (e.g., based on team member obtaining the attribute over time) as reflected in a score). In some aspects, the software instructions, when executed by the one or more processors, can further cause the one or more processors to: (6) cause a notification to be sent regarding at least one of the first score and the modified first team profile (e.g., triggered by a significant change in a score, for example, by at least 10%, at least 20%, at least 30%, at least 40%, at least 50%, and/or a significant modification to a team profile, for example, a change in team member(s), at least one of a new workplace preference, attribute and skill being added, and/or a determination that a previous desired workplace preference, attribute and/or skill is now deemed to be possessed by the first team).

In some aspects, the first set of review data can compose an at least partially completed first review form, and the software instructions, when executed by the one or more processors, can cause the one or more processors to: (1) upon receiving the at least partially completed first review form, modify the first review form based at least in part on the first set of review data to at least one of: remove a question (e.g., based on determining answers relating to the question are not useful); add a question (e.g., based on determining additional information is needed in addition to an earlier question); clear an answer (e.g., based on not getting a suitable answer based on the original question); modify an answer (e.g., where an answer was unclear, and present a modified answer to confirm or correct); replace a question (e.g., based on determining answers provided to a previous question are not useful, on-point, and/or complete); and modify a question (e.g., based on determining answers provided to the pre-modified question are not useful, on-point, and/or complete), and (2) present, via the first team interface, the modified at least partially completed review form.

Also provided herein is a system for assisting in managing teams, comprising: one or more processors; and a memory storing software instructions that, when executed by the one or more processors, cause the one or more processors to: obtain workplace preference data corresponding to a candidate; present, via a first user interface, a review form associated with the candidate (e.g., to a team member, a peer, a manager); receive, via the first user interface, a first set of review data corresponding to the candidate and the review form; modify the review form based at least in part on the first set of review data; present, via a second user interface (e.g., different from the first user interface), the modified review form associated with the candidate (e.g., to the same reviewer of the review form, to a different reviewer than the reviewer of the review form); receive, via the second user interface, a second set of review data corresponding to the candidate and the modified review form; and assign the candidate to a first team based at least in part on the workplace preference data, and at least one of the first and second sets of review data (e.g., assign to a new position within a team the candidate is a part of; assign to a new team that candidate was not previously a part of).

In some aspects, the software instructions, when executed by the one or more processors, can cause the one or more processors to: present, via the first user interface, the modified review form associated with the candidate (e.g., clarifying a question where a first answer received from the first user interface was unclear; the review form having pre-filled answers based at least in part on the first set of review data; the review form with questions removed based on a change in position or role of the candidate since a previous review, for example, the previous review corresponding to the first review data); and receive, via the first user interface, a third set of review data corresponding to the candidate and the modified review form. In some aspects, assigning the candidate to the first team can further be based at least in part on the third set of review data.

In some aspects, software instructions, when executed by the one or more processors, can cause the one or more processors to: further modify the modified review form based at least in part on the second set of review data; present via the first user interface, the twice modified first review form (e.g., where a question was added or modified based on an answer to the modified review form; where second review data is associated with a reviewer that provided the first review data and an explanation is requested from the reviewer); and receive, via the first user interface, a third set of review data corresponding to the candidate and the twice modified review form. In some aspects, assigning the candidate to the first team is further based at least in part on the third set of review data.

In some aspects, modifying the review form can comprise at least one of removing a question, adding a question, replacing a question, modifying a question, and pre-filling an answer of the review form based at least in part on the first set of review data.

In some aspects, the first set of review data composes an at least partially completed review form, and the software instructions, when executed by the one or more processors, cause the one or more processors to: modify the at least partially completed first review form based at least in part on the first set of review data to at least one of: remove a question (e.g., based on determining answers relating to the question are not useful); add a question (e.g., based on determining additional information is needed in addition to an earlier question); clear an answer (e.g., based on not getting a suitable answer based on the original question); modify an answer (e.g., where an answer was unclear, and present a modified answer to confirm or correct); replace a question (e.g., based on determining answers provided to a previous question are not useful, on-point, and/or complete); and modify a question (e.g., based on determining answers provided to the pre-modified question are not useful, on-point, and/or complete), and present, via the first user interface, the modified at least partially completed review form.

In some aspects, the software instructions, when executed by the one or more processors, cause the one or more processors to: receive, via the first user interface, a third set of review data corresponding to the candidate and the modified at least partially completed review form; calculate a first score of the candidate based at least in part on the first set of review data, the second set of review data, and the third set of review data; modify a candidate profile corresponding to the candidate based at least in part on the first score (e.g., team or position associated with the candidate profile); cause a notification to be sent regarding at least one of the first score and the modified candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via at least one of the first user interface, the second user interface, and a third user interface, at least one of the first score and the modified candidate profile.

In some aspects, the system can further comprise one or more databases storing candidate profiles including a first candidate profile comprising workplace preference data corresponding to the candidate, wherein the software instructions, when executed by the one or more processors, further cause the one or more processors to: calculate a first score of the candidate based at least in part on the first set of review data and the second set of review data; modify the first candidate profile corresponding to the candidate based at least in part on the first score (e.g., team or position associated with candidate); cause a notification to be sent regarding at least one of the first score and the modified first candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via the first user interface, the modified at least partially completed review form.

In some aspects, the software instructions, when executed by the one or more processors, further cause the one or more processors to: receive, via the first user interface, a third set of review data corresponding to the candidate and the modified at least partially completed review form; calculate a first score of the candidate based at least in part on the first set of review data, the second set of review data, and the third set of review data; modify a candidate profile corresponding to the candidate based at least in part on the first score (e.g., team associated with candidate profile); cause a notification to be sent regarding at least one of the first score and the modified candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via at least one of the first user interface, the second user interface, and a third user interface, at least one of the first score and the modified candidate profile.

In some aspects, the system further comprises one or more databases storing candidate profiles including a first candidate profile comprising workplace preference data corresponding to the candidate, wherein the software instructions, when executed by the one or more processors, further cause the one or more processors to: calculate a first score of the candidate based at least in part on the first set of review data and the second set of review data; modify the first candidate profile corresponding to the candidate based at least in part on the first score (e.g., team associated with candidate); cause a notification to be sent regarding at least one of the first score and the modified first candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via at least one of the first user interface, the second user interface, and a third user interface, at least one of the first score and the modified first candidate profile.

In some aspects, the software instructions, when executed by the one or more processors, cause the one or more processors to: receive, via at least one of the first user interface, the second user interface, and a third user interface, a third set of review data corresponding to the candidate and the review form and a fourth set of review data corresponding to the candidate and the review form; and wherein modifying the review form is further based at least in part on a third set of review data and the fourth set of review data (e.g., when the same or substantially the same answer is always given for a question).

In some aspects, the software instructions, when executed by the one or more processors, cause the one or more processors to: assign a first weight to a first score corresponding to the candidate and the first set of review data based at least in part on at least one of a number of modifications made to the review form based at least in part on the first set of review data, a seniority of the first reviewer, a score associated with the first reviewer, and a number of reviews received from the first category of reviewers (e.g., number of peers reviewing a candidate; percentage of peers reviewing a candidate); assign a second weight to a second score corresponding to the candidate and the second set of review data based at least in part on at least one of a number of modifications made to the second review form based at least in part on the second set of review data, a seniority of the second reviewer, a score associated with the second reviewer, and a number of reviews received from the second category of reviewers; assign an overall score to the candidate based at least in part on the first score, the first weight, the second score and the second weight; and modify a candidate profile associated with the candidate based at least in part on the overall score.

In some aspects, the system further comprises one or more databases storing candidate profiles, candidate questions, candidate answers, and at least one of attributes and skills corresponding to each candidate answer of the candidate answers, wherein obtaining the workplace preference data comprises: presenting, via a candidate interface, a set of candidate questions from the one or more databases to a candidate; receiving, via the candidate interface, a set of candidate answers responding to a set of candidate questions; and determining a set of attributes of the candidate based at least in part on the candidate answers and a query of the one or more databases; and determining the workplace preference data of the candidate based at least in part on the set of attributes.

Other advantages and benefits of the disclosed compositions and methods will be apparent to one of ordinary skill with a review of the following drawings and detailed description.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 is a block diagram illustrating an example wired or wireless system that may be used in connection with various embodiments described herein;

FIG. 2 illustrates user interfaces communicatively coupled to one or more databases, which may be used in connection with various embodiments described herein;

FIG. 3 illustrates and example of a performance module that may be incorporated into a system, in accordance with various embodiments disclosed herein;

FIG. 4A illustrates an example public search portion of a flow diagram of a system, in accordance with various embodiments disclosed herein;

FIG. 4B illustrates an example job seeker portion of the flow diagram of the system of FIG. 4A;

FIG. 4C illustrates a first part of an example employer portion of the flow diagram of the system of FIG. 4A; and

FIG. 4D illustrates a second part of the example employer portion of the flow diagram of the system of FIG. 4A.

### DETAILED DESCRIPTION

Provided herein are systems and methods for assisting in managing teams. The present disclosure generally relates to the human resources management systems and provides embodiments of a fully integrated team-based human resource management platform that provides a comprehensive platform covering all the core processes of total human resource management to align personnel based on team performance and integration. The embodiments herein provide for improved platform that address the shortcomings of conventional systems.

After reading this description it will become apparent to one skilled in the art how to implement the invention in various alternative embodiments and alternative applications. However, all the various embodiments of the present invention will not be described herein. It is understood that the embodiments presented here are presented by way of an example only, and not limitation. As such, this detailed description of various alternative embodiments should not be construed to limit the scope or breadth of the present invention as set forth below.

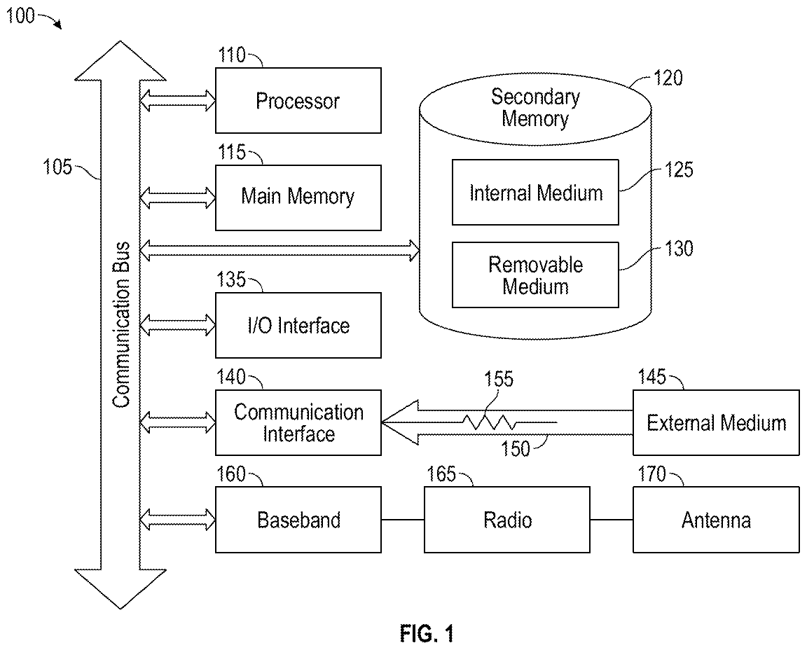

Turning to FIG. 1, a block diagram illustrating an example wired or wireless system according to embodiments of the present disclosure is provided. The platform may be implemented as, for example, a processing device 100 of FIG. 1.

FIG. 1 is a block diagram illustrating an example wired or wireless system 100 that may be used in connection with various embodiments described herein. For example, system 100 may be used as or in conjunction with one or more of the mechanisms, processes, methods, or functions described herein. System 100 can be a server or any conventional personal computer, or any other processor-enabled device that is capable of wired or wireless data communication. Other computer systems and/or architectures may be also used, as will be clear to those skilled in the art.

System 100 preferably includes one or more processors, such as processor 110.

Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 110. Examples of processors which may be used with system 100 include, without limitation, the Pentium® processor, Core i7® processor, and Xeon® processor, all of which are available from Intel Corporation of Santa Clara, Calif.

Processor 110 is preferably connected to a communication bus 105. Communication bus 105 may include a data channel for facilitating information transfer between storage and other peripheral components of system 100. Furthermore, communication bus 105 may provide a set of signals used for communication with processor 110, including a data bus, address bus, and control bus (not shown). Communication bus 105 may comprise any standard or non-standard bus architecture such as, for example, bus architectures compliant with industry standard architecture (ISA), extended industry standard architecture (ELISA), Micro Channel Architecture (MCA), peripheral component interconnect (PCI) local bus, or standards promulgated by the Institute of Electrical and Electronics Engineers (IEEE) including IEEE 188 general-purpose interface bus (GPM), IEEE 696/S-100, and the like.

System 100 preferably includes a main memory 115 and may also include a secondary memory 120. Main memory 115 provides storage of instructions and data for programs executing on processor 110, such as one or more of the functions and/or modules described herein. For example, the main memory 115 may provide storage of instructions and data for programs for executing the example methods as described herein. It should be understood that programs stored in the memory and executed by processor 110 may be written and/or compiled according to any suitable language, including without limitation C/C++, Java, JavaScript, Perl, Visual Basic, .NET, and the like. Main memory 115 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

Secondary memory 120 may optionally include an internal memory 125 and/or a removable medium 130. Removable medium 130 is read from and/or written to in any well-known manner. Removable storage medium 130 may be, for example, a magnetic tape drive, a compact disc (CD) drive, a digital versatile disc (DVD) drive, other optical drive, a flash memory drive, etc.

Removable storage medium 130 is a non-transitory computer-readable medium having stored thereon computer-executable code (e.g., disclosed software modules) and/or data. The computer software or data stored on removable storage medium 130 is read into system 100 for execution by processor 110.

In alternative embodiments, secondary memory 120 may include other similar mean for allowing computer programs or other data or instructions to be loaded into system 100. Such means may include, for example, an external storage medium 145 and a communication interface 140, which allows software and data to be transferred from external storage medium 145 to system 100. Examples of external storage medium 145 may include an external hard disk drive, an external optical drive, an external magneto-optical drive, etc. Other examples of secondary memory 120 may include semiconductor-based memory such as programmable read-only memory (PROM), erasable programmable read-only memory (EPROM), electrically erasable read-only memory (EEPROM), or flash memory (block-oriented memory similar to EEPROM).

System 100 may include a communication interface 140. Communication interface 140 allows software and data to be transferred between system 100 and external devices, networks, or other information sources. For example, computer software or executable code may be transferred to system 100 from a network server via communication interface 140. Examples of communication interface 140 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 100 with a network or another computing device. Communication interface 140 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 140 are generally in the form of electrical communication signals 155. These signals 155 may be provided to communication interface 140 via a communication channel 150. In an embodiment, communication channel 150 may be a wired or wireless network, or any variety of other communication links. Communication channel 150 carries signals 155 and can be implemented using a variety of wired or wireless communication means including wire or cable, fiber optics, conventional phone line, cellular phone link, wireless data communication link, radio frequency (“RF”) link, or infrared link, just to name a few.

Computer-executable code (i.e., computer programs, such as the disclosed application, or software modules) is stored in main memory 115 and/or the secondary memory 120. Computer programs can also be received via communication interface 140 and stored in main memory 115 and/or secondary memory 120. Such computer programs, when executed, enable system 100 to perform the various functions of the disclosed embodiments as described herein.

In this description, the term “computer-readable medium” is used to refer to any non-transitory computer-readable storage media used to provide computer-executable code (e.g., software and computer programs) to system 100. Examples of such media include main memory 115, secondary memory 120 (including internal memory 125, removable medium 130, and external storage medium 145), and any peripheral device communicatively coupled with communication interface 140 (including a network information server or other network device). These non-transitory computer-readable mediums are means for providing executable code, programming instructions, and software to system 100.

In an embodiment that is implemented using software, the software may be stored on a computer-readable medium and loaded into system 100 by way of removable medium 130, I/O interface 135, or communication interface 140. In such an embodiment, the software is loaded into system 100 in the form of electrical communication signals 155. The software, when executed by processor 110, preferably causes processor 110 to perform the features and functions described herein.

In an embodiment, I/O interface 135 provides an interface between one or more components of system 100 and one or more input and/or output devices. In various embodiments, the I/O interface 135 provides an interface between the components of system 100 and one or more devices or system external to the system 100 (e.g., user devices communicating with system 100 over a network). Other example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and the like.

System 100 may also include optional wireless communication components that facilitate wireless communication over a voice network and/or a data network. The wireless communication components comprise an antenna system 170, a radio system 165, and a baseband system 160. In system 100, radio frequency (RF) signals are transmitted and received over the air by antenna system 170 under the management of radio system 165.

In one embodiment, antenna system 170 may comprise one or more antennae and one or more multiplexors (not shown) that perform a switching function to provide antenna system 170 with transmit and receive signal paths. In the receive path, received RF signals can be coupled from a multiplexor to a low noise amplifier (not shown) that amplifies the received RF signal and sends the amplified signal to radio system 165.

In an alternative embodiment, radio system 165 may comprise one or more radios that are configured to communicate over various frequencies. In an embodiment, radio system 165 may combine a demodulator (not shown) and modulator (not shown) in one integrated circuit (IC). The demodulator and modulator can also be separate components. In the incoming path, the demodulator strips away the RF carrier signal leaving a baseband receive signal, which is sent from radio system 165 to baseband system 160.

Baseband system 160 also codes digital signals for transmission and generates a baseband transmit signal that is routed to the modulator portion of radio system 165. The modulator mixes the baseband transmit signal with an RF carrier signal generating an RF transmit signal that is routed to antenna system 170 and may pass through a power amplifier (not shown). The power amplifier amplifies the RF transmit signal and routes it to antenna system 170, where the signal is switched to the antenna port for transmission.

Baseband system 160 is also communicatively coupled with processor 110, which may be a central processing unit (CPU). Processor 110 has access to data storage areas 115 and 120. Processor 110 is preferably configured to execute instructions (i.e., computer programs, such as the disclosed example methods) that can be stored in main memory 115 or secondary memory 120. Computer programs can also be received from baseband processor 160 and stored in main memory 115 or in secondary memory 120, or executed upon receipt. Such computer programs, when executed, enable system 100 to perform the various functions of the disclosed embodiments. For example, data storage areas 115 or 120 may include various software modules.

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art.

Furthermore, those of skill in the art will appreciate that the various illustrative logical blocks, modules, circuits, and method steps described in connection with the figures and the embodiments disclosed herein can often be implemented as electronic hardware, computer software, or combinations of both. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA, or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

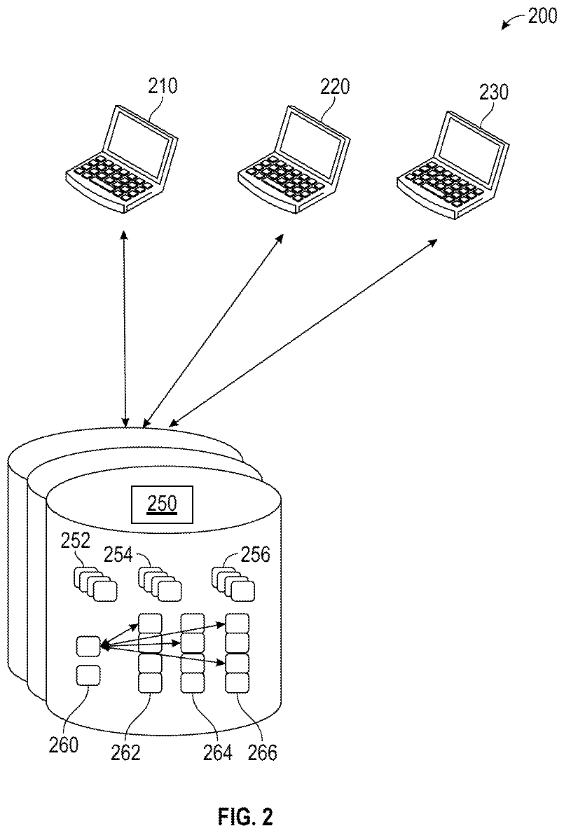

FIG. 2 illustrates user interfaces 210, 220, and 230 of a system 200 (which can include some or all elements of system 100) for assisting in managing teams communicatively coupled to one or more databases 250, which may be used in connection with various embodiments described herein. In some aspects, each of 210, 220, 230 and 250 could include some or all elements of system 100. One or more databases 250 can be configured to store one or more sets of data associated with system 200. For example, one or more databases 250 can be configured to store team profiles 252 that represent a past, current (full or with open positions) and/or contemplated team, which can include team name data, team location data, team member data, team attributes data, team workplace preferences data, team skills data, team member attributes data, team member workplace preferences data, team member skills data, historical data, team score data, team review data, team report data, team member score data, team member review data, team member report data, and/or any other suitable data representative of a past, current, and/or contemplated team. As another example, one or more databases 250 can be configured to store candidate profiles 254 that represent a past, existing, potential, or desired candidate, which can include candidate name data, candidate location data, candidate attributes data, candidate workplace preferences data, candidate skills data, historical data, candidate score data, candidate report data, candidate's previous teams data, candidate's previous position data, candidate review data, and/or any other suitable data representative of a past, existing, potential, or desired candidate. Such data 256 can include, among other things, floor plan data (e.g., office, laboratory, or dormitory floor plan data), gig data, compensation data, demographic data, biometric data, complaint data (e.g., relating to complaints from or against a candidate), disciplinary action data, benefits data, health data, awards data, and/or demand data. It should be appreciated that one or more databases 250 can store any data associated with system 200 that may be useful in assisting in managing teams of any kind. It should also be appreciated that references to team profiles, candidate profiles, review forms, reports, reviews, scores, attributes, workplace preferences, skills, or any other items stored in a database are references to data associated with virtual team profiles, data associated with virtual candidate profiles, data associated with virtual review forms, data associated with virtual reports, data associated with reviews, data associated with scores, data associated with attributes, data associated with workplace preferences, data associated with skills, etc.

In some aspects, a set of team profiles can comprise one or more sets of data, for example, position data 260, workplace preferences data 262, skills data 264, and candidate data 266 (and/or any other suitable data such as attributes, review and/or compensation data), and subsets of one or more of the workplace preferences data 262, skills data 264, and candidate data 266 and/or other data can be associated with position data 260.

In some aspects, a set of candidate profiles can comprise one or more sets of data, for example, candidates data (e.g., name, age, degree, graduation year, start date), positions data, workplace preferences data, skills data, and attributes data (and/or any other suitable data such as review and/or compensation data), and subsets of one or more of the positions data, workplace preferences data, skills data, and attributes data and/or any other suitable data can be associated with the candidate data.

In some aspects, one or more data stored in one or more databases 250 can be modified based on one or more user inputs via user interfaces (e.g., 210, 220, 230).

For example, in some aspects, a system for assisting in managing teams comprises one or more processors, one or more databases in communication with the one or more processors, and a memory storing software instructions. The one or more databases can be configured to store, among other data, team profiles comprising a first team profile, a second team profile, and a third team profile, and wherein each team profile comprises team positions associated with at least one of preferred skills, preferred attributes, and preferred workplace preferences. When the software instructions are executed by the one or more processors, the instructions cause the one or more processors to: present, via a first team interface, a first review form associated with a first team and a first team profile; receive a first set of review data corresponding to the first team, the first team profile and the first review form; present, via a second team interface, a second review form associated a second team and a second team profile; receive a second set of review data corresponding to the second team, the second team profile and the second review form; determine a preferred skill, a preferred attribute, and a preferred workplace preference associated with a high performing team position of a third team profile based at least in part on the first set of review data and the second set of review data; modify the third team profile based on determining the preferred skill, the preferred attribute, and the preferred workplace preference associated with the high performing team position of the third team profile; and store the modified third team profile in the one or more databases. In some aspects, at least one of a preferred skill, a preferred attribute, and a preferred workplace preference associated with a team position of the third team profile is modified. In some aspects, a team profile (e.g., first, second and/or third profile) can include team members associated with positions on the team. In some aspects, a team profile can lack one or more team members associated with one or more positions on the team (e.g., a team profile where one or more positions need to be filled).

In some aspects, the first, second and third teams comprise three different teams. In some aspects, the first, second and third teams are in three different departments. In some aspects, the first, second and third teams are in three different locations and can comprise teams in the same or different departments. In some aspects, the first, second and third teams are teams of different companies. In some aspects, the first and second teams have a common team member.

As another example, in some aspects, a system for assisting in managing teams is provided, comprising one or more processors and a memory storing software instructions that, when executed by the one or more processors, cause the one or more processors to: obtain workplace preference data corresponding to a candidate; present, via a first user interface, a review form associated with the candidate (e.g., a review form with selectable scores (e.g., between 1-10, between 1-5), optionally with comment fields, a review form with questions to be answered in a text box); receive a first set of review data corresponding to the candidate and the review form (e.g., selected scores, text or other inputs answering questions of the review form)); modify the review form based at least in part on the first set of review data (e.g., remove a question from the form when a highest or lowest score possible is given without comments; remove a question from the form when the same score is given multiple times by the same or different reviewers; pre-fill a selection based on the first set of review data for presenting to the same reviewer in the future so the reviewer can easily identify whether a score or answer should be modified); present, via a second user interface, the modified review form associated with the candidate (this modified form can be presented to, for example, another reviewer, the same reviewer, or a manager—e.g., for approval); receive, a second set of review data corresponding to the candidate and the modified review form; and/or assign the candidate to a first team based at least in part on the workplace preference data, and at least one of the first and second sets of review data.

In some aspects, the system comprises one or more databases 250 configured to store the review forms, the review data, and/or the modified review forms. In some aspects, a team profile is modified based on assigning the candidate to the first team. In some aspects, the modified team profile is at least one of stored in the one or more databases and presented, via a user interface, to a user (e.g., a team manager).

In some aspects, assigning the candidate to the first team comprises removing the candidate from a second team.

In some aspects, the one or more databases 250 can be configured to store candidate profiles including a candidate profile comprising workplace preference data corresponding to the candidate, wherein the software instructions further cause the one or more processors to: modify the candidate profile associated with the candidate based at least in part on at least one of the first set of review data and the second set of review data; and store the modified candidate profile in the one or more databases.

In some aspects, the software instructions further cause the one or more processors to: assign a first weight to a first score corresponding to the first set of review data; assign a second weight to a second score corresponding to the second set of review data; and modify the candidate profile associated with the candidate based at least in part on at least one of the first and second scores. The same or different weights may be assigned to scores based on, for example, the length of time a reviewer has worked with a candidate, the length of time a reviewer has worked at a company, the length of time a reviewer has worked with a team, a position of the reviewer, etc.

In some aspects, the software instructions further cause the one or more processors to: store the modified candidate profile in the one or more databases. In some aspects, one or more of a skill, a workplace preference, and an attribute associated with the candidate profile can be modified.

In some aspects, the one or more databases 250 can be configured to store candidate profiles, candidate questions, candidate answers, and at least one of attributes and skills corresponding to each candidate answer of the candidate answers, wherein obtaining the workplace preference data comprises: presenting, via a candidate interface, a set of candidate questions from the one or more databases to a candidate; receiving, via the candidate interface, a set of candidate answers responding to a set of candidate questions; determining a set of attributes of the candidate based at least in part on the candidate answers and a query of the one or more databases; and determining a workplace preference of the candidate based at least in part on the set of attributes; and optionally store a candidate profile associated with the candidate and at least one of the workplace preference and the set of attributes in the one or more databases.

In some aspects, the software instructions further cause the one or more processors to: receive, via the candidate interface, a mask request; modify the candidate profile to mask at least one of a gender, a race, an ethnicity, an age, and a belief of the candidate based at least in part on the mask request; and present, via an employer interface, the modified candidate profile.

As yet another example, a system for assisting in managing teams is provided, comprising: one or more processors; one or more databases in communication with the one or more processors and configured to store, among other things, team profiles comprising team positions associated with at least one of preferred skills, preferred attributes, and preferred workplace preferences, and candidate profiles comprising candidates associated with at least one of acquired attributes, acquired skills, and acquired workplace preferences; a memory storing software instructions that, when executed by the one or more processors, cause the one or more processors to: obtain, via a first user interface, open position data associated with a team position (e.g., data corresponding to position title, position compensation, position location, and/or team members); determine, via a query of the one or more databases, at least one of a preferred skill, a preferred attribute, and a preferred workplace preference associated with the team position (e.g., based on team profile(s)); and obtain, via a query of the one or more databases, a result set of candidates recommended for an open position associated with the open position data (e.g., based on candidate profile(s)), wherein each of the candidates of the result set of candidates is associated with at least one of an acquired attribute, an acquired skill, and an acquired workplace preference, wherein the at least one of the acquired attribute, the acquired skill, and the acquired workplace preference is associated with the at least one of the preferred skill, the preferred attribute, and the preferred workplace preference associated with the team position.

In some aspects, the software instructions, when executed by the one or more processors, cause the one or more processors to modify a team profile associated with the team position and store it in the one or more databases.

In some aspects, the result set of candidates comprises ranked candidates. In some aspects, the software instructions further cause the one or more processors to: receive, via a second user interface, placement data associated with a candidate of the result set of candidates being assigned to the open position; and modify a team profile associated with the team position based at least in part on the placement data.

As yet another example, a system for assisting in managing teams is provided, comprising: one or more processors; and a memory storing software instructions that, when executed by the one or more processors, cause the one or more processors to: present, via a first user interface, a first review form associated with a candidate; present, via a second user interface, a second review form associated with the candidate; receive a first set of review data corresponding to the first review form and the candidate; receive a second set of review data corresponding to the second review form and the candidate; modify the first review form based at least in part on the first and second sets of review data; and present, via a third user interface, the modified first review form.

In some aspects, the first and second user interfaces are the same. In some aspects, the first and second review forms are the same. In some aspects, the first and second sets of review data are associated with a first reviewer.

As yet another example, a system for assisting in managing teams is provided, comprising: one or more processors, one or more databases in communication with the one or more processors, and a memory storing software instructions. The one or more databases can be configured to store, among other data, team profiles comprising a first team profile, a second team profile, and a third team profile, and wherein each team profile comprises team positions associated with at least one of preferred skills, preferred attributes, and preferred workplace preferences; candidate profiles, candidate questions, candidate answers, and at least one of attributes and skills corresponding to each candidate answer of the candidate answers; review forms, the review data, and/or the modified review forms. When the software instructions are executed by the one or more processors, the instructions cause the one or more processors to do any suitable combination of the following: present, via a first team interface, a first review form associated with a first team and a first team profile; receive a first set of review data corresponding to the first team, the first team profile and the first review form; present, via a second team interface, a second review form associated a second team and a second team profile; receive a second set of review data corresponding to the second team, the second team profile and the second review form; determine a preferred skill, a preferred attribute, and a preferred workplace preference associated with a high performing team position of a third team profile based at least in part on the first set of review data and the second set of review data; modify the third team profile based on determining the preferred skill, the preferred attribute, and the preferred workplace preference associated with the high performing team position of the third team profile; store the modified third team profile in the one or more databases. In some aspects, at least one of a preferred skill, a preferred attribute, and a preferred workplace preference associated with a team position of the third team profile is modified; present, via a first user interface, a review form associated with the candidate (e.g., a review form with selectable scores (e.g., between 1-10, between 1-5), optionally with comment fields, a review form with questions to be answered in a text box); receive a first set of review data corresponding to the candidate and the review form (e.g., selected scores, text or other inputs answering questions of the review form)); modify the review form based at least in part on the first set of review data (e.g., remove a question from the form when a highest or lowest score possible is given without comments; remove a question from the form when the same score is given multiple times by the same or different reviewers; pre-fill a selection based on the first set of review data for presenting to the same reviewer in the future so the reviewer can easily identify whether a score or answer should be modified); present, via a second user interface, the modified review form associated with the candidate (this modified form can be presented to, for example, another reviewer, the same reviewer, or a manager—e.g., for approval); receive, a second set of review data corresponding to the candidate and the modified review form; assign the candidate to a first team based at least in part on the workplace preference data, and at least one of the first and second sets of review data; assign a first weight to a first score corresponding to the first set of review data; assign a second weight to a second score corresponding to the second set of review data; and modify the candidate profile associated with the candidate based at least in part on at least one of the first and second scores; store the modified candidate profile in the one or more databases. In some aspects, one or more of a skill, a workplace preference, and an attribute associated with the candidate profile can be modified; obtain, via a first user interface, open position data associated with a team position; determine, via a query of the one or more databases, at least one of a preferred skill, a preferred attribute, and a preferred workplace preference associated with the team position; and/or obtain, via a query of the one or more databases, a result set of candidates recommended for an open position associated with the open position data, wherein each of the candidates of the result set of candidates is associated with at least one of an acquired attribute, an acquired skill, and an acquired workplace preference, wherein the at least one of the acquired attribute, the acquired skill, and the acquired workplace preference is associated with the at least one of the preferred skill, the preferred attribute, and the preferred workplace preference associated with the team position.

As yet another example, a system for assisting in managing teams is provided, comprising: one or more processors; one or more databases in communication with the one or more processors and configured to store team profiles comprising a first team profile, a second team profile, and a third team profile, and wherein each team profile comprises team positions associated with at least one of preferred skills, preferred attributes, and preferred workplace preferences; and a memory storing software instructions that, when executed by the one or more processors, cause the one or more processors to: present, via a first team interface, a first review form associated with a first team and a first team profile; receive, via the first team interface, a first set of review data corresponding to the first team, the first team profile and the first review form; present, via a second team interface, a second review form associated with a second team and a second team profile; receive, via the second team interface, a second set of review data corresponding to the second team, the second team profile and the second review form; determine at least one of a preferred skill, a preferred attribute, and a preferred workplace preference associated with a high performing team position of a third team profile based at least in part on the first set of review data and the second set of review data; modify the third team profile based on determining the at least one of the preferred skill, the preferred attribute, and the preferred workplace preference associated with the high performing team position of the third team profile; store the modified third team profile in the one or more databases; and present, via a third team interface, the modified third team profile. As one non-limiting example, it is contemplated that the first review form associated with the first team and the first team profile can comprise a high score (e.g., at least 7/10, at least 8/10, at least 9/10) and/or positive review related to one aspect of the team member's overall performance (e.g., a team member's quality of work product), and a low score (e.g., below or equal to 4/10, below or equal to 3/10, below or equal to 2/10) and/or negative review related to another aspect of the team member's overall performance (e.g., the team member's ability to work well with others). The second review form associated with the second team and the second team profile can comprise a high score and/or positive review related to one aspect of the team member's overall performance (e.g., a team member's quality of work product; how likely the reviewer is to request the team member being reviewed to be a part of its future team(s)), and a low score and/or negative review related to another aspect of the team member's overall performance (e.g., the team member's ability to work well with others). The system could determine that a low score and/or negative review related to one aspect of a team member's overall performance (e.g., the team member's ability to work well with others) has a high correlation (e.g., above a threshold of 50%) with a high score and/or positive review related to another aspect of the team member's overall performance (e.g., quality of work product). Based in whole or in part on this determination, the system could determine that a lack of ability to work well with others is a preferred/desirable attribute associated with a high performing team position (which can be the same or different type of team position) of an entirely different third team.

In some aspects, the first set of review data can compose an at least partially completed first review form, and the second review form can comprise the at least partially completed review form. In some aspects, the first set of review data can compose an at least partially completed review form, and the software instructions, when executed by the one or more processors, can cause the one or more processors to: (1) upon receiving the at least partially completed first review form, modify the first review form based at least in part on the first set of review data to at least one of: remove a question (e.g., based on determining answers relating to the question are not useful); add a question (e.g., based on determining additional information is needed in addition to an earlier question); replace a question (e.g., based on determining answers provided to a previous question are not useful, on-point, and/or complete); modify a question (e.g., based on determining answers provided to the pre-modified question are not useful, on-point, and/or complete); and pre-fill an answer (e.g., based on a previous answer(s) provided by the same and/or different reviewers). In some aspects, the second review form can comprise the modified review form.

In some aspects, the first set of review data can compose an at least partially completed first review form, and the software instructions, when executed by the one or more processors, can cause the one or more processors to: (1) upon receiving the at least partially completed first review form, modify the first review form based at least in part on the first set of review data to at least one of: remove a question (e.g., based on determining answers relating to the question are not useful); add a question (e.g., based on determining additional information is needed in addition to an earlier question); replace a question (e.g., based on determining answers provided to a previous question are not useful, on-point, and/or complete); modify a question (e.g., based on determining answers provided to the pre-modified question are not useful, on-point, and/or complete); and pre-fill an answer (e.g., based on a previous answer(s) provided by the same and/or different reviewers), and (2) present, via the first team interface, the modified first review form. In some aspects, the software instructions, when executed by the one or more processors, can further cause the one or more processors to: (3) receive, via the first team interface, a third set of review data corresponding to the first team, the first team profile, and the modified first review form; (4) calculate a first score of the first team based at least in part on the first set of review data and the third set of review data; and (5) modify the first team profile based at least in part on the first score (e.g., modify team members, modify workplace preferences, attributes, skills, etc. for example, based on determining the team now possesses a previously desired attribute (e.g., based on team member obtaining the attribute over time) as reflected in a score). In some aspects, the software instructions, when executed by the one or more processors, can further cause the one or more processors to: (6) cause a notification to be sent regarding at least one of the first score and the modified first team profile (e.g., triggered by a significant change in a score, for example, by at least 10%, at least 20%, at least 30%, at least 40%, at least 50%, and/or a significant modification to a team profile, for example, a change in team member(s), at least one of a new workplace preference, attribute and skill being added, and/or a determination that a previous desired workplace preference, attribute and/or skill is now deemed to be possessed by the first team).

In some aspects, the first set of review data can compose an at least partially completed first review form, and the software instructions, when executed by the one or more processors, can cause the one or more processors to: (1) upon receiving the at least partially completed first review form, modify the first review form based at least in part on the first set of review data to at least one of: remove a question (e.g., based on determining answers relating to the question are not useful); add a question (e.g., based on determining additional information is needed in addition to an earlier question); clear an answer (e.g., based on not getting a suitable answer based on the original question); modify an answer (e.g., where an answer was unclear, and present a modified answer to confirm or correct); replace a question (e.g., based on determining answers provided to a previous question are not useful, on-point, and/or complete); and modify a question (e.g., based on determining answers provided to the pre-modified question are not useful, on-point, and/or complete), and (2) present, via the first team interface, the modified at least partially completed review form.

As yet another example, a system for assisting in managing teams is provided, comprising: one or more processors; and a memory storing software instructions that, when executed by the one or more processors, cause the one or more processors to: obtain workplace preference data corresponding to a candidate; present, via a first user interface, a review form associated with the candidate (e.g., to a team member, a peer, a manager); receive, via the first user interface, a first set of review data corresponding to the candidate and the review form; modify the review form based at least in part on the first set of review data; present, via a second user interface (e.g., different from the first user interface), the modified review form associated with the candidate (e.g., to the same reviewer of the review form, to a different reviewer than the reviewer of the review form); receive, via the second user interface, a second set of review data corresponding to the candidate and the modified review form; and assign the candidate to a first team based at least in part on the workplace preference data, and at least one of the first and second sets of review data (e.g., assign to a new position within a team the candidate is a part of; assign to a new team that candidate was not previously a part of).

In some aspects, the software instructions, when executed by the one or more processors, can cause the one or more processors to: present, via the first user interface, the modified review form associated with the candidate (e.g., clarifying a question where a first answer received from the first user interface was unclear; the review form having pre-filled answers based at least in part on the first set of review data; the review form with questions removed based on a change in position or role of the candidate since a previous review, for example, the previous review corresponding to the first review data); and receive, via the first user interface, a third set of review data corresponding to the candidate and the modified review form. In some aspects, assigning the candidate to the first team can further be based at least in part on the third set of review data.

In some aspects, software instructions, when executed by the one or more processors, can cause the one or more processors to: further modify the modified review form based at least in part on the second set of review data; present via the first user interface, the twice modified first review form (e.g., where a question was added or modified based on an answer to the modified review form; where second review data is associated with a reviewer that provided the first review data and an explanation is requested from the reviewer); and receive, via the first user interface, a third set of review data corresponding to the candidate and the twice modified review form. In some aspects, assigning the candidate to the first team is further based at least in part on the third set of review data.

In some aspects, modifying the review form can comprise at least one of removing a question, adding a question, replacing a question, modifying a question, and pre-filling an answer of the review form based at least in part on the first set of review data.

In some aspects, the first set of review data composes an at least partially completed review form, and the software instructions, when executed by the one or more processors, cause the one or more processors to: modify the at least partially completed first review form based at least in part on the first set of review data to at least one of: remove a question (e.g., based on determining answers relating to the question are not useful); add a question (e.g., based on determining additional information is needed in addition to an earlier question); clear an answer (e.g., based on not getting a suitable answer based on the original question); modify an answer (e.g., where an answer was unclear, and present a modified answer to confirm or correct); replace a question (e.g., based on determining answers provided to a previous question are not useful, on-point, and/or complete); and modify a question (e.g., based on determining answers provided to the pre-modified question are not useful, on-point, and/or complete), and present, via the first user interface, the modified at least partially completed review form.

In some aspects, the software instructions, when executed by the one or more processors, cause the one or more processors to: receive, via the first user interface, a third set of review data corresponding to the candidate and the modified at least partially completed review form; calculate a first score of the candidate based at least in part on the first set of review data, the second set of review data, and the third set of review data; modify a candidate profile corresponding to the candidate based at least in part on the first score (e.g., team or position associated with the candidate profile); cause a notification to be sent regarding at least one of the first score and the modified candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via at least one of the first user interface, the second user interface, and a third user interface, at least one of the first score and the modified candidate profile.

In some aspects, the system can further comprise one or more databases storing candidate profiles including a first candidate profile comprising workplace preference data corresponding to the candidate, wherein the software instructions, when executed by the one or more processors, further cause the one or more processors to: calculate a first score of the candidate based at least in part on the first set of review data and the second set of review data; modify the first candidate profile corresponding to the candidate based at least in part on the first score (e.g., team or position associated with candidate); cause a notification to be sent regarding at least one of the first score and the modified first candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via the first user interface, the modified at least partially completed review form.

In some aspects, the software instructions, when executed by the one or more processors, further cause the one or more processors to: receive, via the first user interface, a third set of review data corresponding to the candidate and the modified at least partially completed review form; calculate a first score of the candidate based at least in part on the first set of review data, the second set of review data, and the third set of review data; modify a candidate profile corresponding to the candidate based at least in part on the first score (e.g., team associated with candidate profile); cause a notification to be sent regarding at least one of the first score and the modified candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via at least one of the first user interface, the second user interface, and a third user interface, at least one of the first score and the modified candidate profile.

In some aspects, the system further comprises one or more databases storing candidate profiles including a first candidate profile comprising workplace preference data corresponding to the candidate, wherein the software instructions, when executed by the one or more processors, further cause the one or more processors to: calculate a first score of the candidate based at least in part on the first set of review data and the second set of review data; modify the first candidate profile corresponding to the candidate based at least in part on the first score (e.g., team associated with candidate); cause a notification to be sent regarding at least one of the first score and the modified first candidate profile (e.g., triggered by a significant change in a score, for example, by at least 10%, at least 20%, at least 30%, at least 40%, at least 50%, and/or a significant modification to a candidate profile, for example, a change in team, a change in position, a change in at least one of a workplace preference, attribute and skill); and present, via at least one of the first user interface, the second user interface, and a third user interface, at least one of the first score and the modified first candidate profile.

In some aspects, the software instructions, when executed by the one or more processors, cause the one or more processors to: receive, via at least one of the first user interface, the second user interface, and a third user interface, a third set of review data corresponding to the candidate and the review form and a fourth set of review data corresponding to the candidate and the review form; and wherein modifying the review form is further based at least in part on a third set of review data and the fourth set of review data (e.g., when the same or substantially the same answer is always given for a question).

In some aspects, the software instructions, when executed by the one or more processors, cause the one or more processors to: assign a first weight to a first score corresponding to the candidate and the first set of review data based at least in part on at least one of a number of modifications made to the review form based at least in part on the first set of review data, a seniority of the first reviewer, a score associated with the first reviewer, and a number of reviews received from the first category of reviewers (e.g., number of peers reviewing a candidate; percentage of peers reviewing a candidate); assign a second weight to a second score corresponding to the candidate and the second set of review data based at least in part on at least one of a number of modifications made to the second review form based at least in part on the second set of review data, a seniority of the second reviewer, a score associated with the second reviewer, and a number of reviews received from the second category of reviewers; assign an overall score to the candidate based at least in part on the first score, the first weight, the second score and the second weight; and modify a candidate profile associated with the candidate based at least in part on the overall score.

In some aspects, the system further comprises one or more databases storing candidate profiles, candidate questions, candidate answers, and at least one of attributes and skills corresponding to each candidate answer of the candidate answers, wherein obtaining the workplace preference data comprises: presenting, via a candidate interface, a set of candidate questions from the one or more databases to a candidate; receiving, via the candidate interface, a set of candidate answers responding to a set of candidate questions; and determining a set of attributes of the candidate based at least in part on the candidate answers and a query of the one or more databases; and determining the workplace preference data of the candidate based at least in part on the set of attributes.

Although three user interfaces and three databases are illustrated in FIG. 2, it should be appreciated that a system as disclosed herein can comprise any suitable number of user interfaces and any suitable number of databases.

It should be appreciated that the team-based systems of the various embodiments described herein can include various components/modules as described herein. These team-based systems can utilize an algorithm and assessment to align new candidates and current employees with existing and/or new teams based on, for example, workplace preferences and hard skills. An example algorithm and assessment are described in U.S. Pat. No. 8,185,424, issued May 22, 2012, entitled “Soft Skills Job Matching System and Method,” the contents of which are incorporated by reference in their entirety.

By creating high-performing teams and companies that focus on hard skills and how each person fits into the team, collaboration and teamwork are enhanced and baked into the culture. Some of the contemplated components of systems of various embodiments described herein can include one or more of the following modules.

Talent Acquisition Component or Module (TechneHire™ and TechneTeam™)

The talent acquisition component can utilize an assessment or test to balance new and/or existing teams by aligning an individual's workplace preferences and skills with positions, team dynamics and/or organizational goals. A candidate (e.g., job seeker) can elect to take the assessment or test, for example, during the application process. As used herein, the term “candidate” should be interpreted broadly to include a candidate that a company or other organization has engaged with (e.g., sent an application confirmation email), a job seeker who has or has not yet applied for a position with a company or other organization and has not received any engagement from the company or organization, or an employee of the company or other organization that could potentially be considered and/or interested in another position and/or team of the company.

In some aspects, the talent acquisition component ranks, weighs, and matches one or more of an applicant's hard skills, work style, attributes and workplace preferences to create or modify high-functioning teams that work. The results can be submitted along with the candidate's application.

In some aspects, a system is provided, which can assess workplace preferences and skills of candidates to align the candidates with positions on existing and/or new teams. With some contemplated assessments (e.g., the assessments described in U.S. Pat. No. 8,185,424, incorporated by reference in its entirety), 13 attributes, such as power, achievement, affiliation, and excitement, are mapped to 39 statements (although any suitable number of attributes and statements are contemplated). Each statement can be linked to one of thirteen workplace style attributes. The statements can be randomly paired by the algorithm, and the candidate can choose between two statements randomly paired by the system and presented to the candidate via a user interface. The system can adjust the weight applied to the attributes. The assessment can be considered complete when all thirteen attributes have been tested twice, resulting in a 13-dimension vector. In order to ensure that job seekers can't try to game the system, all the choices or questions can be neutral, carefully worded positive statements. The job seeker can be asked to choose between two positive options to avoid giving the impression that any of the statements about work style are regarded as more favorable or important for the job at hand. Based on the candidate's choices/selections, the system can determine whether the candidate falls into one or more of possible personal workstyle preference clusters, for example, the following 4 workstyle preferences:

Evangelists, who are most comfortable within an exciting field and workgroup, desire an environment that is achievement-based, are team players, but rely on themselves to perform independently, and are not afraid to take risks.

Team Spirits, who are an extroverted group, very affiliated with or part of a group, prefer collaboration to doing things on their own, like to do activities with a team, are okay with giving or taking direction from others, work well with others and can balance their needs against those of the group.

Subject Matter Experts, who are independent, solution-oriented, like to define their goals, enjoy figuring out solutions to problems, do not rely on workplace kudos for confidence, are not interested in being in a leadership position, and do not need to have responsibility to perform well.

Leaders, who are best defined by their desire for responsibility, happy to be decisive, regardless of whether they are leading a group or are simply self-directed, desire power as an expression of personal responsibility, like to define goals, responsible for outcome, not only for themselves, but for others, like action, but not excitement just for the sake of activity, and desires forward action that leads somewhere.

All four of these workstyle types have important qualities to offer a team, and many consider them to be equally valuable with no type more valuable than the other. The way candidates or employees having certain workplace preferences are combined and balanced on any given team can create a highly-functioning team. By obtaining and/or identifying the candidate's attributes or workplace preferences, the system can select and/or recommend a candidate whose attributes and/or workplace preferences meet the specific needs of the position (e.g., as set forth in a team profile or position profile) and provides the necessary balance for the team.

While 4 workstyle preference clusters are described above, it should be appreciated that all suitable workplace preferences are contemplated, and such preferences can be categorized according to any suitable method and/or standards (e.g., according to DiSC™ workplace behavioral styles—Dominance, Influence, Steadiness, Conscientiousness).

Based on the results, the system can assign an overall percentage-grade that identifies the applicant as belonging to one of four distinct Personal Work Style Preferences Clusters.

Additionally, candidates can be evaluated for hard skills, for example, based on a keyword search and an inventory of self-identified skills. The combination of the personal Workplace Preferences (also referred to herein as workstyle preferences) and hard skills can enable qualified candidates to be ranked based on the aggregate of these results.

The information gathered and/or determined by the system can be used to assign candidates to existing and new teams (e.g., sports team, gig worker, dormitory floor, shared dorm room, employee team), and the data can get richer over time, allowing users to see what combinations of soft skills and hard skills create successful teams to solve specific problems.

Candidates can be assessed during the initial resume screening process by weighing their hard skills along with thirteen unique “soft” attributes. The potential candidate's profile (e.g., a virtual candidate profile stored in a database), which can include the candidate's workplace preferences, attributes (and/or attribute assessments), skills and other data, can then be weighed against the hiring manager and/or team leader's preferences, and/or preferences or desired skills, attributes, and/or workplace preferences of a team profile (e.g., a virtual team profile stored in a database) or position profile (e.g., a virtual position profile). The potential candidate's profile can also be weighed and ranked in relation to the profiles of other applicants and/or members of the target team or work group.

Work cultures typically ask teams of individuals to come together to, among other things, support strategic initiatives, develop new products, implement new technologies, and provide operational-support activities. In performing these activities, cohesive and well-managed teams provide organizational efficiencies and a competitive advantage. Fractured, poorly integrated teams typically result in missed milestones; cost overruns; and poorly designed products, services, or processes. All this can have an immediate negative impact on bottom-line performance.

However, assembling project teams whose members have the requisite technical abilities, hard skills, and professional knowledge to support each other is often not enough. A team that possesses all the requisite hard skills and knowledge may still not function well. The most effective teams are often viewed as those in which the team members also balance each other out by exhibiting different workplace preferences. Thus, it can be desirable to staff a balanced team that possesses not only complementary hard skills, but also complementary workstyle preferences. The analysis described herein can enable organizations to form work groups that are well balanced and have a capacity to work well together.

Viewed from another perspective, the talent acquisition component can expose the additional information about personal workplace preferences that recruiters and team leaders need or will preferably have to build balanced teams. This workplace preference analysis can enable team leaders to analyze and adjust the composition of existing teams by introducing underrepresented work styles and/or workplace preferences. By developing a complementary fit between workers, recruiters and team leaders, teams that exhibit powerful and productive synergies can be created. Over time it becomes possible to see which combinations of soft skills and hard skills create successful teams to solve specific problems and the data becomes richer.

In some aspects, the TechneTeam component of some contemplated systems can provide, among other things, one or more of the following: (1) For an employer: employer dashboard to manage overview of teams, job postings, and applicants, Kanban-style dashboard to manage applicant through hiring process, workplace preference assessment review for candidates, candidate hard skill assessment, ability to administer workplace preference assessment to current team and/or employees, decision board with ability to model potential candidates to fit into current and/or developing team, applicant comparison, applicant database with ability to message candidate by email, ability for hiring manager to follow potential candidates, create company profile, skills inference based on machine learning, resume builder, text message candidates, and manager-level dashboard to understand issues in addition to hiring on team; (2) For a job seeker: job search engine, ability to take workplace preferences assessment, job match based on workplace preferences and hard skills, candidate portal with job recommendation capability, resume vault stores multiple resume versions, targeted resume submission tailored to specific positions, ability to bulk apply to multiple positions, ability for job seeker to follow companies.

Diversity and Inclusion Component or Module (EqualHire™)

The diversity and inclusion component can enable an employer and/or other team recruiter to review applications without attention to one or more of gender, age, race, and nationality, allowing them to place qualifications, skill sets, and personal workplace preferences front and center.

The team recruiter can put to use egalitarian hiring practices, masking information about gender, race, ethnicity, and age behind a neutral avatar.

The mask can be activated by the job applicant, who can choose to apply as a “neutral” candidate with the EqualHire mask turned on. A recruiter wishing to comply with diversity requirements can specify that they will only consider applications with the mask turned on or can select to have applicant avatars and/or other information masked. The masking can remain on until, for example, the recruiter or hiring manager establishes contact with the applicant.

The masking feature challenges and enables employers and job seekers alike to place hard skills and personal workplace preferences front and center in the early stages of the resume selection process, which can preclude or at least reduce unconscious bias. The recruiters and hiring managers can focus on what really counts—the applicant's qualifications, hard skills, soft skills, and workplace style—without being distracted by gender, race, age, or ethnicity.

Studies show that companies with more diverse workforces perform better financially. But the importance of diversified teams can extend beyond gender, race, ethnicity, and age, to diversity of workplace preferences, skills, attributes, and work styles.

Performance Management Component or Module (TechneReview™)

The performance management component can, among other things, address the need for performance management tools that are reinvented to manage and measure the shift from a hierarchical top down view of ranking, rating and paying people based on designated goals—to businesses measuring organizational performance by the team, which can allow for transparent goals, information and feedback that is free flowing and continuous, with people rewarded for skills and team fit rather than position in the hierarchy.

In the new team-based human resource management system, people move from team to team as necessary or work on multiple teams. Consequently, their projects and goals change quite frequently during the year in terms of technical, collaborative, and professional abilities, not just managerial growth.

In some aspects, the performance management component provides for measuring personal performance (as measured by reviews of one, some or all members of a team reviewing an individual's performance), and team performance (as measured by reviews of one, some or all members of a team reviewing the team's performance). The team profile (e.g., desired attributes, desired workplace preferences, desired skills, open positions, candidates (e.g., employees) associated with the team profile) may be changed dynamically based on the measured personal performance and team performance.

The personal performance review data can be integrated with employee directories or profile pages to make them part of everyday work, rather than something completed at the end of the year. Goals can be transparent, easy to change, and tracked using a tracking mechanism to measure progress. Data can be mined and loaded into analytics systems with customer and team feedback directly included in end-of-year performance discussions. Performance management tied into the recruitment process can give decision makers more detailed data, helping important decisions to become more open and data driven.

The team performance may be evaluated by some or all team members via one or more review forms (e.g., virtual questionnaire), which may be presented to the team members at various times (e.g., before a new member joins a team, 6 months after the new member joins a team, 12 months after the new member joins a team, a combination thereof). In some aspects, the review form can be sent to a representative sample of the team before hiring each new member, and again 6 months after the new member is hired. The questionnaire can be sent to all team members once a year (or at any other suitable interval) to create and keep a record of the team effectiveness in the long run. The questionnaire can be taken on demand via one or more user interfaces, and the effectiveness score of the team can be updated based inputs the system receives corresponding to the on demand survey (and/or other review). This process can determine, along with the team turnover score and the company turnover rate, the effectiveness of the systems in reducing turnover and increasing revenue. Some reviews may be ad hoc reviews, reviews based on pulse surveys, anonymous reviews, and/or any other suitable reviews. An analysis engine can analyze reviews or survey results and modify a team profile. The modified team profile can be stored in one or more databases or presented, via a management interface, to a team manager or other user (e.g., recruiter).

The personal performance of a candidate may be evaluated by some or all team members via one or more review forms (e.g., virtual questionnaire), which may be presented to the team members at various times. In some aspects, the review form can be sent to a representative sample of the team before the candidate joins the team, and again 6 months after the candidate joins the team. The questionnaire can be sent to all team members once a year (or at any other suitable interval) to create and keep a record of the candidate's performance in the long run. The questionnaire can be taken on demand via one or more user interfaces, and the candidate score and/or candidate profile can be updated based on inputs the system receives corresponding to the on demand survey (and/or other reviews). Some reviews may be ad hoc reviews, reviews based on pulse surveys, anonymous reviews, and/or any other suitable reviews. An analysis engine can analyze reviews or survey results and modify a candidate profile and/or team member profile. The modified candidate profile and/or team member profile can be stored in one or more databases, presented, via a user interface, to a team manager or other user (e.g., recruiter, the candidate).

The personal performance review data, the team performance review data, the team scores, team profiles, and any other suitable data may be stored in one or more databases communicatively coupled to one or more processors of various systems described herein.

Workforce Management Component or Module (TechneGig™)

Globally, about 77 million people are freelancers, which is about half the size of the US workforce. About 40% of younger full-time workers also now work part-time.

The TechneGig workforce management component can utilize the TechneTeam engine to place external gig workers within a company. As the gig worker onboards, TechneGig can implement onboarding training and other helpful online training.

As the idea of working remotely becomes a daily part of the workplace, TechneGig can be used to manage not only the gig worker, but also vendors and the supplies and tools workers receive to work from home. In some aspects, the gig worker or new employee can order their desk, chair, and laptop using the workforce management component. In some aspects, the gig worker can access a stipend or request reimbursement related to their rent/mortgage, internet, and cell phone, etc. via the workforce management component.

Integrated Talent Management Component or Module (TechneCareer™ and TechneFresher™)

TechneFresher—Partnering with leading universities, TechneFresher can provide a smooth transition from college life to work life. A position eligible for entry-level candidates can automatically posts to career portals within the university and college system. College students can simply apply and the candidate's resume along with their workstyle preferences can be posted to the hiring manager's decision board for easy review.

TechneCareer—Succession Planning: Successful candidates who are later reviewed and/or scored as successful on the job can be targeted as high-value employees and slotted for subject-matter expert or management positions. Retention Planning: Salaries, based on pattern of performance and success, coupled with demands for skills inside company, can compete with the outside marketplace. It can be better to retain a high-performing employee than lose out to another company. Also, low performers in one team can become high performers on another team. Career management: Machine learning can be utilized to recommend career moves within the company, which can create a global workforce landscape. High performing team composition can optimize a global workforce.

Collaboration Component or Module (TechneKnowHow™)

The collaboration component can provide for integrated video and audio collaboration within the system. The collaboration component can provide video and audio collaboration within the talent acquisition module. In some aspects, the collaboration component can provide collaboration and messaging tools within a team, between teams, and/or within a company.

Data Analytics and Planning Component or Module (TechneAnalytics™ and TechneDataLake™)

Basic HR Analytics can require identifying the key problem or opportunity you hope to work on to use data to make data-driven decisions. Machine Learning can power up when large data sets are attained. The company data can be used, for example, to: (a) Measure the proportion of selected applicants who are later judged successful on the job; (b) Create individual company data sets instead of incorporating hundreds of data elements from a third-party AI application; (c) train the AI data; and (d) fine tune data based on company data lake. The machine learning tools can alert the company of challenges or potential issues before they become a problem.

Additional modules can include, for example, compensation and benefits, corporate learning, wellbeing management, and engagement and culture.

Contemplated systems can advantageously analyze candidates and teams within a company (based on one or more of internal company data and external data) to, for example, remove redundant workers from a team (e.g., redundant skills, attributes, or workplace preferences where the redundancy does not add significant value), add or replace a team member to fill a needed skill, attribute, or workplace preference, eliminate silos based on locations and fully leverage candidates regardless of location and manage a global workforce, recreate successful teams with team members having complementary and needed skills, attributes, and workplace preferences, or start with an analysis of “A” players to optimize contribution, and then “B” and “C” players to raise contribution. The data becomes richer over time like any good machine learning tool, allowing managers and other users to create a balanced, highly functioning team based on data obtained from similar and/or even different/unrelated projects. People can move either from role to role, project to project, function to function, etc. based on business demands, which can change the way promotion and upward mobility is perceived or managed.

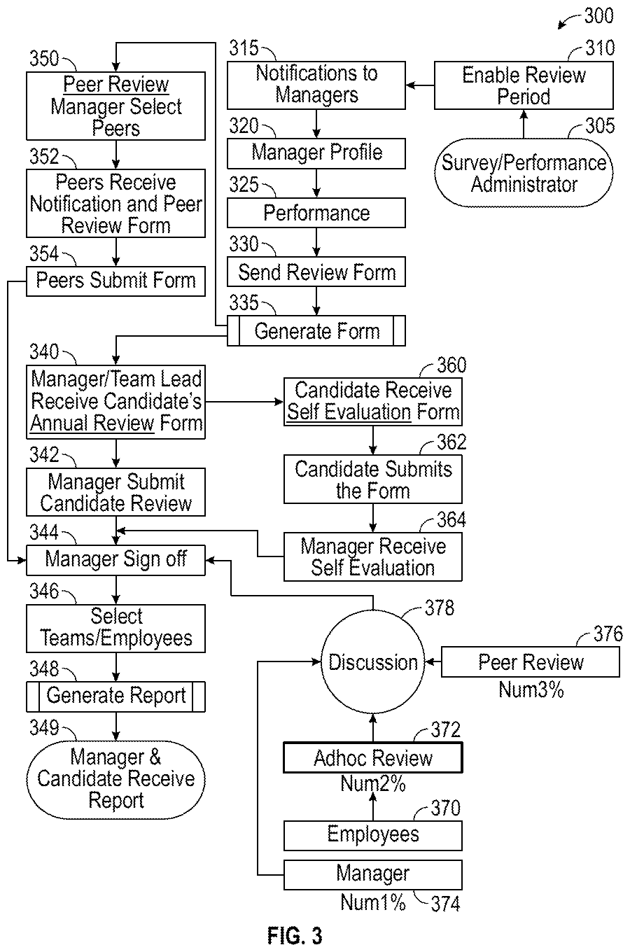

FIG. 3 illustrates an example of a performance module 300 that may be incorporated into a system (e.g., system 100) for assisting in managing teams, in accordance with embodiments disclosed herein. Embodiments of the performance module may provide a team-based multi-fold performance management system through a multi-fold performance evaluation mechanism. For example, in the illustrative example, the multi-fold performance evaluation mechanism may be a three-fold mechanism. An example three-fold performance evaluation mechanism may comprise a first evaluation mechanism (e.g., an annual performance review mechanism), a second evaluation mechanism (e.g., peer review mechanism), and third evaluation mechanism (e.g., an ad hoc feedback review mechanism). Each mechanism may be weighted and aggregated. The multi-fold performance evaluation mechanism may also include a self-evaluation mechanism that may be weighted and aggregated with the other mechanism. Each aspect to the performance module bay be controlled by a manager through enhanced controls and customization for each team and/or team member to enhance the performance evaluation.

In the illustrative example shown in FIG. 3, the module may comprise three kinds of forms. For example, a peer review form, an annual review form, and a self-evaluation form. One or more the forms can be controlled by a manager, for example, to edit the form and the questions included therein. The manager may also operate the system to send these performance forms to employees and the team members. That is, forms may be sent according to team structure and members therein such that the completed forms may be associated with a specific team for team-based evaluation.

An administrator can access an administrator portal 305 to initiate a review period 310 within the system and set a review period during which the manager can generate the review forms 335 and send the forms to employees. In some aspects, a notification is sent to the manager 315, and the manager can access a manager profile 320, select employees for whom performance reviews will be requested 325, and cause the review forms to be generated 330. Once the review forms are generated 335, peers of the employees being reviewed can submit peer reviews 350 and manager/team lead of the employees being reviewed can submit manager/team lead reviews 340. Some or all peers of an employee being reviewed can receive a notification along with a peer review form 352. The peers can complete and submit the review form 354 for manager sign off (or approval) 344. The manager/team lead can also complete and submit a review form 342, and sign off 344. The manager/team lead can cause the candidate to receive a self-evaluation form 360, which the candidate can complete and submit 362 to the manager who receives the completed form 364 and signs off (or approves the review) 344.

In some embodiments, only forms enabled by the administrator may be generated and sent by the manager. For example, if a specific form is enabled, the manager may access the form from his/her profile, generate the form for completion by employees and send the various forms (e.g., peer review forms, annual, and/or self-evaluation forms).

In some embodiments there may be an option to choose teams such that forms can be sent across the teams. In some embodiments, sending a peer review may require selection of candidates for sending a peer review form in order to generate the form. To enable review form, the manager may select the team and send the form. For example, the team members of the selected team may review an annual review form and/or selected candidates may receive the peer review form for completion. In some instances, as designated by the manager, one or more self-evaluation forms may be generated so individuals may evaluate their own performance and submit that form to the manager.

In some aspects, all review forms completed are required to be signed off or approved by the manager 344 to be considered and compiled into a report 348. To reduce bias and minimize individuals (or groups of individuals) from gaming the system, a weight can be applied to each form category of review forms, for example, the managers review and the peer review. For example, a weight Num1% may be assigned to the manager review 374 of an employee, and a weight Num2% may be assigned to the aggregated peer reviews 376 of an employee. Another weight of Num3% may be applied to ad hoc reviews 372, described below. The weight for each category may be any percentage desired to totaling 100%. In some embodiments, Num2% and Num3% may sum to the difference of 100% and Num1%. Num2% and Num3% may be the same weight in some embodiments or be different weights. The weight values may be set as desired by the system administrator and may be adjusted over time. Contemplated systems may automatically adjust a weight assigned to reviews of a group (e.g., manager(s), peer(s)), for example, based on the number of completed review forms relative to review requests sent out to a group (e.g., manager(s), peer(s)).

Ad hoc review may be similar to the peer review, in that ad hoc review is received from peers. However, while peer review is based on forms controlled by the manager, ad hoc reviews may be controlled by the peer performing the review. For example, say a peer wants to give someone an ad hoc review, the system allows that peer to go into his or her profile and select to give an ad hoc review. The system will present categories for selection by the peer and generate a form there and the peer is able to submit a review without relying on a manager-controlled form.

In some embodiments, ad hoc review may be used to give reviews from members on other teams that a given employee has worked on beside the employee's main team. For example, in many organizations, employees work across many teams, not just a single team. Due to complexities in the organization and differing practices by managers and team leaders, often reviews from outside an employee's main team may be lost and/or not documented. Furthermore, more ancillary team members (e.g., members working on a team outside of their main team) may not be requested to submit a manager controller review form. Thus, the ad hoc review may be used by employees 370 or others to submit reviews outside of a main team.

In some aspects, one or more of the managers, the peers and other employees can have a discussion 378 regarding the reviews submitted prior to requesting manager sign off. Once the reviews are signed off by the manager 344, a report 348 of an employee and/or team corresponding to the reviews 346 may be generated. For example, in some embodiments, each review type contains a plurality of review categories and/or text input fields. The categories may have selectable scores (or ranking) associated with each category. Generating the report may include aggregating each score for a given category from each submitted review type and averaging the scores to generate a single score of each category. Furthermore, generating the report may also include taking an average of scores across all categories to generate a single score for a given employee and/or team. Text inputs for each input field from reviewers may be compiled into a respective text input that may be included in the generated report. In some implementations, employees or team members may access the report from a performance dashboard GUI generated by the system. From the dashboard, the employee can access the reviews received and the reviews he or she gave to somebody 349. One or more databases (e.g., databases 250) can be configured to store any or all the forms, completed review forms, reports, review data, rankings, scores, categories, inputs and other data described herein.

A non-limiting advantage of the performance module described herein, differing from prior conventional systems, may include that the manager, peer review, and the ad hoc review are weighted. Another non-limiting advantage of the performance module described herein is that team members from across the organization and across functional teams are able to review employees based on their performance on each respective team. The employees review may thus be team-based and team centric such that separate performance evaluations may be provided for each team and used to not only evaluate the performance of the employee but also the performance of the team. Another non-limiting advantage is that the manager is provided flexibility to control the review forms and issue them across teams and peers to effectuate the team-based review process.

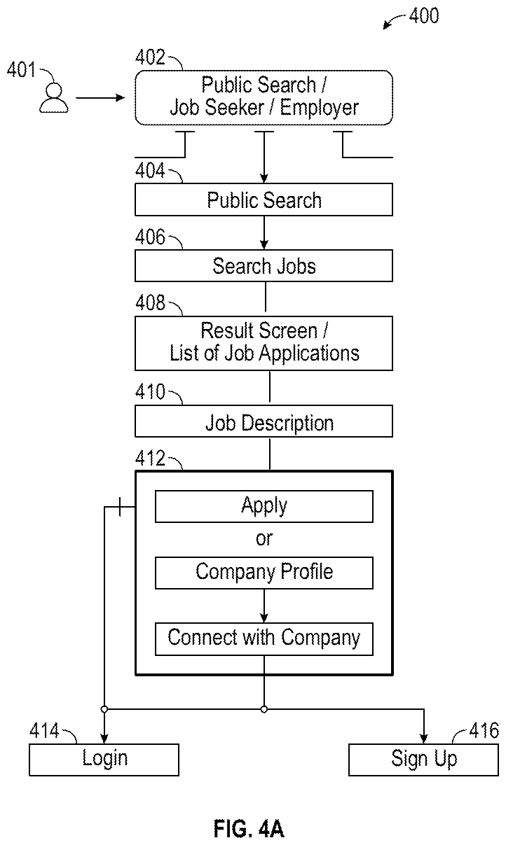

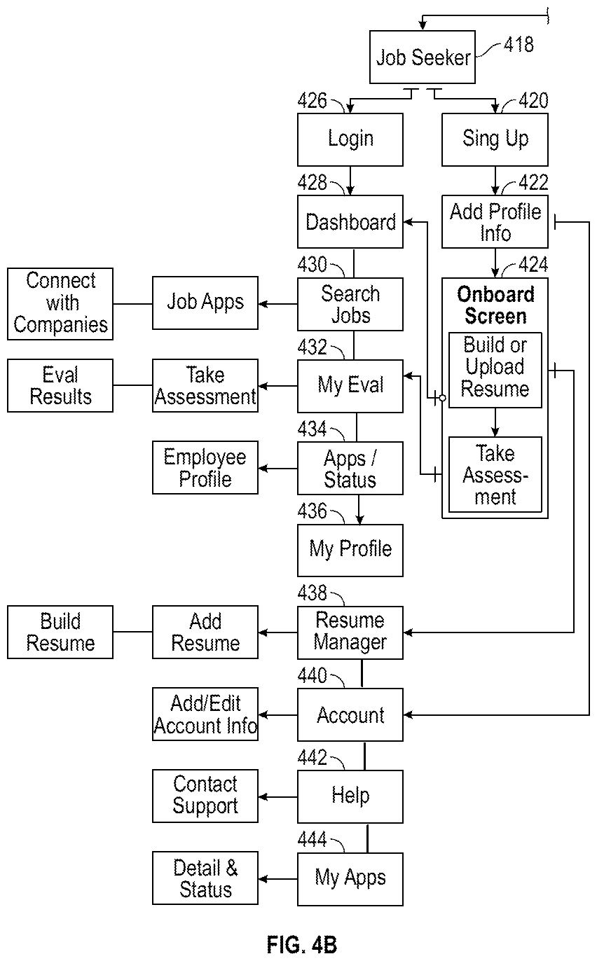

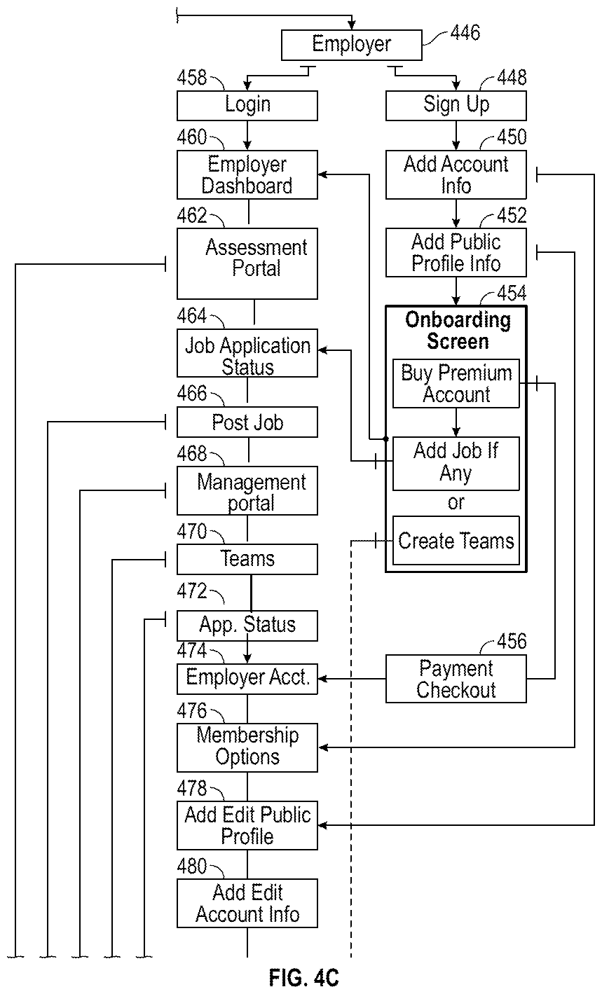

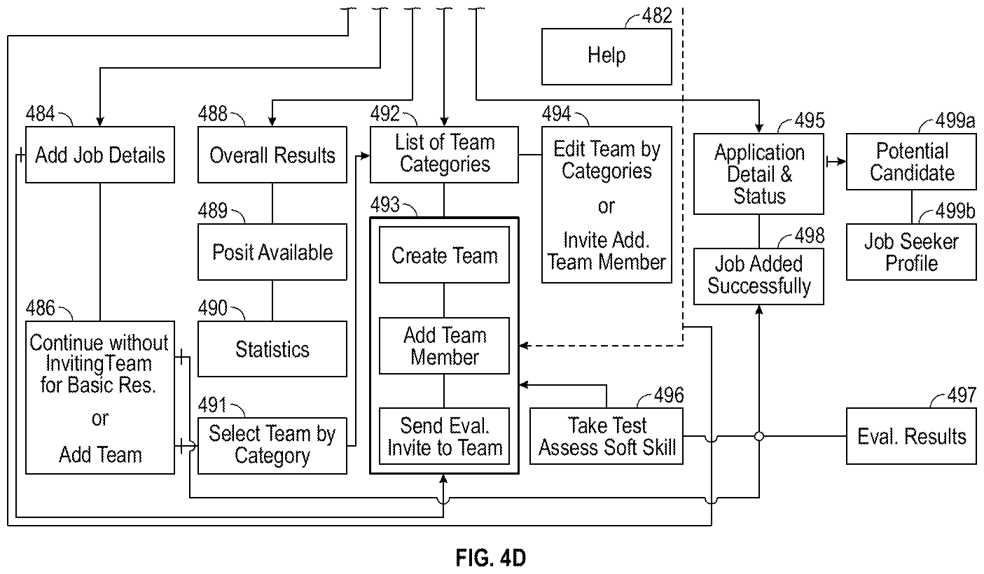

Now turning to FIGS. 4A-4D, an example flow diagram 400 of a system (e.g., 100) according to one or more embodiments described herein is illustrate. FIGS. 4A-4D depicts the system comprising a plurality of modules, for example, as described above. The example illustrates a subset of the modules that may be included in the system; however, it will be appreciated that the flow diagram of FIGS. 4A-4D may include one or more of the modules described in any of the examples and embodiments herein. For example, flow chart 400 illustrates a job seeker side talent acquisition module (e.g., referred to herein as the TechneTeam module), a public search module, an employer side talent acquisition module, and employer side team assessment module. However, other modules may be included, such as but not limited to, an EqualHire module, Performance module, and career management module. As another example, the job seeker side and employer side talent acquisition module may include features for incorporating gig workers and/or college graduates, and not only lateral, full employees.

As shown in FIG. 4A, a user 401 of contemplated systems can utilize a public search, job seeker, and/or employer portal 402. In some aspects, a public search portal 404 be utilized to access a job search portal 406 and initiate a job search, view a result screen with a list of jobs available to apply for 408 (customized or general) along with corresponding job descriptions 410, and/or utilize an application portal 412 to apply for a position and/or access a company profile and connect with the company. The user 401 can access a login portal 414, which can provide user 401 with access to a job seeker portal, and/or can access a sign up portal 416 to create an account and obtain login information.

As shown in FIG. 4B, a user 401 (e.g., an employee job seeker or outside job seeker) can utilize a job seeker portal 418 to access a login page 426 or sign up page 420. Through sign up page 420, user 401 can add profile information 422, and utilize an onboard screen 424 to build or upload a resume and take an assessment (for the system to identify workplace preferences of the job seeker). From the login page 426, the user can access dashboard 428, which can allow the user to access one or more portals, and the job seeker's profile page 436. The dashboard 428 can provide the user with options to access one or more portals, including, for example: a “search jobs” portal 430, through which the job seeker can search jobs, apply for jobs, and/or connect with companies; a “my eval” portal 432, through which the job seeker can take an assessment and/or view evaluation results; and/or an “app/status” portal 434 through which the job seeker can view employer profiles associated with applications submitted. The job seeker's profile page 436 can provide the user with options to access one or more portal, including, for example: a “resume manager” portal 438, through which a job seeker can add and/or build a resume; an “account” portal, through which the job seeker can add/edit account information; a “help” portal, through which the job seeker can be presented with options to contact support; and/or a “my apps” portal 444, through which the job seeker can view applications submitted and current status.

In some aspects, job seekers can be either active or passive, becoming active at a certain point. In some aspects, job seekers can also be categorized by level of education, experience, hard skills, function, and industry. In some aspects, contemplated systems can be agnostic to those categories and address the entire population of job seekers independently of where they are in their careers, instead focusing on the hard skills and workplace preferences of the job seekers, and collecting resumes and profiles to populate the database so that it brings value to employers.

As shown in FIGS. 4C and 4D, a user 401 can utilize an employer portal 446 to access a login page 458 or sign up page 448. From the sign up page 448, the employer can add account information 450, and one or more of: (a) add public profile information 452, and/edit public profile information 418, be presented with membership options 476, add/edit public profile 478, add/edit account info 480, and/or seek help 482 (e.g., customer support), (b) add public profile information 452, and/or be presented with membership options 476, and (c) utilize an onboarding screen 454 to purchase a premium or paid account, add job postings and/or create teams. If a premium or paid account is selected, the employer can be directed to a payment checkout portal 456. From the onboarding screen 454, the employer can access employer dashboard 460, access the job application status portal 464 and/or access portal 493 for creating and/or modifying teams and/or sending an evaluation invite to a team.

Upon login from the login page 458, the employer can, among other things, one or more of: access the employer dashboard 460, access an assessment portal 462, through which the employer can take a test for assessing desired or preferred workplace preferences and/or attributes, view workplace preferences and/or attributes of potential candidates, otherwise identify desired or preferred workplace preferences and/or attributes of a team or position, and/or identify existing workplace preferences and/or attributes of a team or position. The employer can access a job posting platform 466, access a management portal 468, access a team portal 470, access an application status portal 472 (e.g., number of applications received for each job posting) and/or access an employer account portal to view and/or modify employer account information 474. The employer they can utilize portal 493 to create a team, add, remove and/or substitute team members, and/or send evaluation invitations to team members, for example, after accessing assessment portal 462. The employer can utilize assessment portal 496 to take a test for assessing desired or preferred workplace preferences and/or attributes, view workplace preferences and/or attributes of potential candidates, otherwise identify desired or preferred workplace preferences and/or attributes of a team or position, and/or identify existing workplace preferences and/or attributes of a team or position. The employer can access a results portal 497 to view evaluation results of one or more of a team, a team member, and a job seeker or other potential candidate.

Utilizing job posting portal 466, the employer can add/edit job details 484, and select to invite a team to view and/or modify the posting, continue without inviting the team to view and/or the posting, and/or associate the posting with a team or team profile 486. The employer can receive an alert or notification that the job was added successfully to the system via notification portal 498. The management portal 468 can be utilized to view/access overall results (e.g., team performance results, team member performance results) 488, view available positions 489, and/or view statistics relating to the teams 490. Utilizing the teams portal 470, the employer can access and/or a list of team categories 492, edit team categories, create teams, and/or invite additional team members 494 to a team, and/or send evaluation/review invites to a team of members thereof. Utilizing application status portal 472, the employer can view application details and status 495, confirm the job posting was added successfully via notification portal 498, and/or view potential candidates 499a and/or job seeker profiles 499b.

It is contemplated that the size of the company and its industry both bring some specificities that need to be considered.

For example, Start-ups with significant budget constraints generally need to hire and retain qualified top talents that are not only the best in the market but who can easily integrate in a small team where the dynamic and promiscuity does not allow for personality or deep workstyle differences that could clash easily. They often lack hiring skills, digital tools, brand awareness in addition to financial means. Getting access to a pool of candidates that would be already categorized by hard skills, soft skills, diversity, and workstyle would contribute to their success in hiring the “right” person.

Small to medium size companies often share some of the challenges expressed above for start-ups. For them, additional challenges can include their employer branding and expanding reach to candidate which requires to build a talent network to have a pool of options ready to fill vacancies. They also compete with large companies and social media reviews can be essential. Finally, they usually lack skills in talent management from onboarding to development to succession planning.

Large companies generally have the competitive advantage of being known with strong finances, and often have an in-house human resources team that is extremely qualified and sometimes specialized in sourcing resumes and recruiting. For them, the key challenge can be to ensure beyond the qualification and experience that the candidates will have the appropriate cultural fit.

It's difficult to know if applicants will properly fit in well with the corporate culture and interact well with current team(s). A firm understanding of how its current employees engage with each other will help to know what kind of questions to ask candidates, and skills, attributes and workplace preferences to seek. Within employers, independently of their size, customers can include recruiters, hiring managers, team managers, team leaders, business human resources, etc. The company can be any type or organization, including businesses, schools, universities, sports teams, stylists, or any other organization having teams, especially where team composition is critical for achieving goals.

Over time, the data gets richer and those utilizing the systems contemplated herein will be able to see, among other things, which combinations of workstyle preferences and hard skills create successful teams to solve specific problems.

### Non-Limiting Embodiments

1. A system for assisting in managing teams, comprising: one or more processors; one or more databases in communication with the one or more processors and configured to store team profiles comprising a first team profile, a second team profile, and a third team profile, and wherein each team profile comprises team positions associated with at least one of preferred skills, preferred attributes, and preferred workplace preferences; and a memory storing software instructions that, when executed by the one or more processors, cause the one or more processors to: present, via a first team interface, a first review form associated with a first team and a first team profile; receive, via the first team interface, a first set of review data corresponding to the first team, the first team profile and the first review form; present, via a second team interface, a second review form associated with a second team and a second team profile; receive, via the second team interface, a second set of review data corresponding to the second team, the second team profile and the second review form; determine at least one of a preferred skill, a preferred attribute, and a preferred workplace preference associated with a high performing team position of a third team profile based at least in part on the first set of review data and the second set of review data; modify the third team profile based on determining the at least one of the preferred skill, the preferred attribute, and the preferred workplace preference associated with the high performing team position of the third team profile; store the modified third team profile in the one or more databases; and present, via a third team interface, the modified third team profile.

2. The system of embodiment 1, wherein the first set of review data composes an at least partially completed first review form, and wherein the second review form comprises the at least partially completed first review form.

3. The system of embodiment 1, wherein the first set of review data composes an at least partially completed first review form, and wherein the software instructions, when executed by the one or more processors, further cause the one or more processors to: upon receiving the at least partially completed first review form, modify the first review form based at least in part on the first set of review data to at least one of: remove a question; add a question; replace a question; modify a question; and pre-fill an answer; and wherein the second review form comprises the modified first review form.

4. The system of embodiment 1, wherein the first set of review composes an at least partially completed first review form, and wherein the software instructions, when executed by the one or more processors, further cause the one or more processors to: upon receiving the at least partially completed first review form, modify the first review form based at least in part on the first set of review data to at least one of: remove a question; add a question; replace a question; modify a question; and pre-fill an answer; and present, via the first team interface, the modified first review form.

5. The system of embodiment 1, wherein the software instructions, when executed by the one or more processors, further cause the one or more processors to: receive, via the first team interface, a third set of review data corresponding to the first team, the first team profile, and the modified first review form; calculate a first score of the first team based at least in part on the first set of review data and the third set of review data; and modify the first team profile based at least in part on the first score.

6. The system of embodiment 5, wherein the software instructions, when executed by the one or more processors, further cause the one or more processors to: cause a notification to be sent regarding at least one of the first score and the modified first team profile; and present, via at least one of the first team interface, the second team interface, the third team interface, and a fourth interface, at least one of the first score and the modified first team profile.

7. The system of embodiment 1, wherein the first set of review data composes an at least partially completed first review form, and wherein the software instructions, when executed by the one or more processors, further cause the one or more processors to: upon receiving the at least partially completed first review form, modify the at least partially completed first review form based at least in part on the first set of review data to at least one: remove a question; add a question; clear an answer; modify an answer; replace a question; and modify a question; and present, via the first team interface, the modified at least partially completed first review form.

8. A system for assisting in managing teams, comprising: one or more processors; and a memory storing software instructions that, when executed by the one or more processors, cause the one or more processors to: obtain workplace preference data corresponding to a candidate; present, via a first user interface, a review form associated with the candidate; receive, via the first user interface, a first set of review data corresponding to the candidate and the review form; modify the review form based at least in part on the first set of review data; present, via a second user interface, the modified review form associated with the candidate; receive, via the second user interface, a second set of review data corresponding to the candidate and the modified review form; and assign the candidate to a first team based at least in part on the workplace preference data, and at least one of the first and second sets of review data.

9. The system of embodiment 8, wherein the software instructions, when executed by the one or more processors, further cause the one or more processors to: present, via the first user interface, the modified review form associated with the candidate; and receive, via the first user interface, a third set of review data corresponding to the candidate and the modified review form; and wherein assigning the candidate to the first team is further based at least in part on the third set of review data.

10. The system of embodiment 8, wherein the software instructions, when executed by the one or more processors, further cause the one or more processors to: further modify the modified review form based at least in part on the second set of review data; present, via the first user interface, the twice modified first review form; and receive, via the first user interface, a third set of review data corresponding to the candidate and the twice modified review form; and wherein assigning the candidate to the first team is further based at least in part on the third set of review data.

11. The system of embodiment 8, wherein modifying the review form comprises at least one of removing a question, adding a question, replacing a question, modifying a question, and pre-filling an answer of the review form based at least in part on the first set of review data.

12. The system of embodiment 8, wherein the first set of review data composes an at least partially completed review form, and wherein the software instructions, when executed by the one or more processors, further cause the one or more processors to: modify the at least partially completed first review form based at least in part on the first set of review data to at least one of: remove a question; add a question; clear an answer; modify an answer; replace a question; and modify a question; present, via the first user interface, the modified at least partially completed review form.

13. The system of embodiment 12, wherein the software instructions, when executed by the one or more processors, further cause the one or more processors to: receive, via the first user interface, a third set of review data corresponding to the candidate and the modified at least partially completed review form; calculate a first score of the candidate based at least in part on the first set of review data, the second set of review data, and the third set of review data; modify a candidate profile corresponding to the candidate based at least in part on the first score; cause a notification to be sent regarding at least one of the first score and the modified candidate profile; and present, via at least one of the first user interface, the second user interface, and a third user interface, at least one of the first score and the modified candidate profile.

14. The system of embodiment 8, further comprising one or more databases storing candidate profiles including a first candidate profile comprising workplace preference data corresponding to the candidate, wherein the software instructions, when executed by the one or more processors, further cause the one or more processors to: calculate a first score of the candidate based at least in part on the first set of review data and the second set of review data; modify the first candidate profile corresponding to the candidate based at least in part on the first score; cause a notification to be sent regarding at least one of the first score and the modified first candidate profile; and present, via at least one of the first user interface, the second user interface, and a third user interface, at least one of the first score and the modified first candidate profile.

15. The system of embodiment 8, wherein the software instructions, when executed by the one or more processors, further cause the one or more processors to: receive, via at least one of the first user interface, the second user interface, and a third user interface, a third set of review data corresponding to the candidate and the review form and a fourth set of review data corresponding to the candidate and the review form; and wherein modifying the review form is further based at least in part on a third set of review data and the fourth set of review data.

16. The system of embodiment 8, wherein the first set of review data corresponds to a first reviewer's review of the candidate, wherein the first reviewer belongs to a first category of reviewers, wherein the second set of review data corresponds to a second reviewer's review, wherein the second reviewer belongs to a second category of reviewers different from the first reviewer, and wherein the software instructions further cause the one or more processors to: assign a first weight to a first score corresponding to the candidate and the first set of review data based at least in part on at least one of a number of modifications made to the review form based at least in part on the first set of review data, a seniority of the first reviewer, a score associated with the first reviewer, and a number of reviews received from the first category of reviewers; assign a second weight to a second score corresponding to the candidate and the second set of review data based at least in part on at least one of a number of modifications made to the second review form based at least in part on the second set of review data, a seniority of the second reviewer, a score associated with the second reviewer, and a number of reviews received from the second category of reviewers; assign an overall score to the candidate based at least in part on the first score, the first weight, the second score and the second weight; and modify a candidate profile associated with the candidate based at least in part on the overall score.

17. The system of embodiment 8, further comprising one or more databases storing candidate profiles, candidate questions, candidate answers, and at least one of attributes and skills corresponding to each candidate answer of the candidate answers, wherein obtaining the workplace preference data comprises: presenting, via a candidate interface, a set of candidate questions from the one or more databases to a candidate; receiving, via the candidate interface, a set of candidate answers responding to a set of candidate questions; and determining a set of attributes of the candidate based at least in part on the candidate answers and a query of the one or more databases; and determining the workplace preference data of the candidate based at least in part on the set of attributes.

Also provided herein is a job search systems, comprising one or more processors, and a memory storing software instructions that, when executed by the one or more processors, cause the one or more processors to: present, via a candidate interface, a set of questions to a first candidate; receive a first set of preference data corresponding to the first candidate and related to the set of questions; assign a first set of attributes to the first candidate based at least in part on the first set of preference data, wherein the first set of attributes correspond to a first set of soft skills; filter a set of job postings to remove at least a first job posting from the set of job postings based at least in part on the first set of attributes; and present, via a user interface, data corresponding to the set of job postings excluding at least the first job posting. In some aspects, the software instructions, when executed by the one or more processors, further cause the one or more processors to: present a masking option, which upon selection masks data relating to at least one of a gender, a race, an ethnicity, an age, and a belief; receive an input relating to selection of the masking option; receive a candidate message from the first candidate; and provide, via an employer interface, at least a portion of the candidate message from the first candidate to an employer with data relating to at least one of the gender, the race, the ethnicity, the age, and the belief masked.

Also provided herein is a computer implemented method for creating a team, comprising: receiving a first set of preference data corresponding to a first candidate; assigning a first set of attributes to the candidate based at least in part on the first set of preference data; and presenting, via the management interface, data corresponding to a recommendation for moving the first candidate from a first position on a first team to at least one of a second position different from the first position and a second team different from the first team based at least in part on the first set of attributes. In some aspects, presenting data corresponding to the recommendation for moving the candidate from the first position on the first team to at least one of the second position different from the first position and the second team different from the first team is based at least in part on a skill of the candidate. In some aspects, presenting data corresponding to the recommendation for moving the candidate from the first position on the first team to at least one of the second position different from the first position and the second team different from the first team is based at least in part a need of at least one of the second position and the second team. The method can optionally comprise one or more of the following steps: receiving a first set of review data corresponding to the first evaluation form; assigning a first weight to a first score corresponding to the first set of review data; receiving a second set of review data corresponding to the second evaluation form; assigning a second weight to a second score corresponding to the second set of review data; and presenting, via a management interface, data corresponding to a second recommendation for repositioning the candidate based at least in part on the first set of attributes, the first score, and the second score. The method can optionally comprise one or more of the following steps: receiving a first set of review data corresponding to the first evaluation form; assigning a first weight to a first score corresponding to the first set of review data; and presenting, via a management interface, data corresponding to a compensation recommendation based at least in part on the first set of attributes and the first score. The method can optionally comprise one or more of the following steps: receiving a second set of preference data corresponding to a second candidate; assigning a second set of attributes to the candidate based at least in part on the second set of preference data; and wherein presenting data corresponding to the recommendation is based at least in part on a comparison of the first set of attributes and the second set of attributes with a need of at least one of the second position and the second team.

Also provided herein is a non-transitory computer-readable medium or media having computer-readable instructions stored thereon that are executable by a processor to: receive a first set of preference data corresponding to a first candidate; assign a first set of attributes to the candidate based at least in part on the first set of preference data; and present, via the management interface, data corresponding to a recommendation for moving the first candidate from a first position on a first team to at least one of a second position different from the first position and a second team different from the first team based at least in part on the first set of attributes. In some aspects, the computer-readable instructions are executable by the processor to: receive a first set of review data corresponding to the first evaluation form; assign a first weight to a first score corresponding to the first set of review data; receive a second set of review data corresponding to the second evaluation form; assign a second weight to a second score corresponding to the second set of review data; and present, via a management interface, data corresponding to a second recommendation for repositioning the candidate based at least in part on the first set of attributes, the first score, and the second score. In some aspects, the computer-readable instructions are executable by the processor to: receive a first set of review data corresponding to the first evaluation form; assign a first weight to a first score corresponding to the first set of review data; and present, via a management interface, data corresponding to a compensation recommendation based at least in part on the first set of attributes and the first score. In some aspects, the computer-readable instructions are executable by the processor to: receive a second set of preference data corresponding to a second candidate; assign a second set of attributes to the candidate based at least in part on the second set of preference data; and wherein presenting data corresponding to the recommendation is based at least in part on a comparison of the first set of attributes and the second set of attributes with a need of at least one of the second position and the second team. In some aspects, the computer-readable instructions are executable by the processor to: present a set of questions to the first candidate, wherein the first set of preference data relate to the set of questions.

Thus, specific examples of systems and methods for assisting in managing teams have been disclosed. It should be apparent, however, to those skilled in the art that many more modifications besides those already described are possible without departing from the inventive concepts herein. While examples and variations of the many aspects of the invention have been disclosed and described herein, such disclosure is provided for purposes of explanation and illustration only. Thus, various changes and modifications may be made without departing from the scope of the claims.

Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refer to at least one of something selected from the group consisting of A, B, C . . . and N, the text should be interpreted as requiring only one element from the group, not A plus N, or B plus N, etc.

The terminology used herein is for the purpose of describing particular cases only and is not intended to be limiting. The below terms are discussed to illustrate meanings of the terms as used in this specification, in addition to the understanding of these terms by those of skill in the art. As used herein and in the appended claims, the singular forms “a,” “an,” and “the” include plural referents unless the context clearly dictates otherwise. It is further noted that the claims can be drafted to exclude any optional element. As such, this statement is intended to serve as antecedent basis for use of such exclusive terminology as “solely,” “only” and the like in connection with the recitation of claim elements, or use of a “negative” limitation.

Reference throughout this specification to “an embodiment” or “an implementation” means that a particular feature, structure, or characteristic described in connection with the embodiment is included in at least one embodiment or implementation. Thus, appearances of the phrases “in an embodiment” in various places throughout this specification are not necessarily all referring to the same embodiment or a single exclusive embodiment. Furthermore, the particular features, structures, or characteristics described herein may be combined in any suitable manner in one or more embodiments or one or more implementations.

The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Certain numerical values and ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

All structural and functional equivalents to the components of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A system for assisting in managing teams, comprising:
one or more processors;
one or more databases in communication with the one or more processors and configured to store team profiles comprising a first team profile, a second team profile, and a third team profile, and wherein each team profile comprises team positions associated with at least one of preferred skills, preferred attributes, and preferred workplace preferences; and
a memory storing software instructions that, when executed by the one or more processors, cause the one or more processors to:
present, via a first team interface, a first review form associated with a first team and a first team profile;
receive, via the first team interface, a first set of review data corresponding to the first team, the first team profile and the first review form;
present, via a second team interface, a second review form associated with a second team and a second team profile;
receive, via the second team interface, a second set of review data corresponding to the second team, the second team profile and the second review form;
determine at least one of a preferred skill, a preferred attribute, and a preferred workplace preference associated with a high performing team position of a third team profile based at least in part on the first set of review data and the second set of review data;
modify the third team profile based on determining the at least one of the preferred skill, the preferred attribute, and the preferred workplace preference associated with the high performing team position of the third team profile;
store the modified third team profile in the one or more databases; and
present, via a third team interface, the modified third team profile.

2. The system of claim 1, wherein the first set of review data composes an at least partially completed first review form, and wherein the second review form comprises the at least partially completed first review form.

3. The system of claim 1, wherein the first set of review data composes an at least partially completed first review form, and wherein the software instructions, when executed by the one or more processors, further cause the one or more processors to:
upon receiving the at least partially completed first review form, modify the first review form based at least in part on the first set of review data to at least one of:
remove a question;
add a question;
replace a question;
modify a question; and
pre-fill an answer; and
wherein the second review form comprises the modified first review form.

4. The system of claim 1, wherein the first set of review composes an at least partially completed first review form, and wherein the software instructions, when executed by the one or more processors, further cause the one or more processors to:
upon receiving the at least partially completed first review form, modify the first review form based at least in part on the first set of review data to at least one of:
remove a question;
add a question;
replace a question;
modify a question; and
pre-fill an answer; and
present, via the first team interface, the modified first review form.

5. The system of claim 4, wherein the software instructions, when executed by the one or more processors, further cause the one or more processors to:
receive, via the first team interface, a third set of review data corresponding to the first team, the first team profile, and the modified first review form;
calculate a first score of the first team based at least in part on the first set of review data and the third set of review data; and
modify the first team profile based at least in part on the first score.

6. The system of claim 5, wherein the software instructions, when executed by the one or more processors, further cause the one or more processors to:
cause a notification to be sent regarding at least one of the first score and the modified first team profile; and
present, via at least one of the first team interface, the second team interface, the third team interface, and a fourth interface, at least one of the first score and the modified first team profile.

7. The system of claim 1, wherein the first set of review data composes an at least partially completed first review form, and wherein the software instructions, when executed by the one or more processors, further cause the one or more processors to:
upon receiving the at least partially completed first review form, modify the at least partially completed first review form based at least in part on the first set of review data to at least one:
remove a question;
add a question;
clear an answer;
modify an answer;
replace a question; and
modify a question; and
present, via the first team interface, the modified at least partially completed first review form.

8. A system for assisting in managing teams, comprising:
one or more processors; and
a memory storing software instructions that, when executed by the one or more processors, cause the one or more processors to:
obtain workplace preference data corresponding to a candidate;
present, via a first user interface, a review form associated with the candidate;
receive, via the first user interface, a first set of review data corresponding to the candidate and the review form;
modify the review form based at least in part on the first set of review data;
present, via a second user interface, the modified review form associated with the candidate;
receive, via the second user interface, a second set of review data corresponding to the candidate and the modified review form; and
assign the candidate to a first team based at least in part on the workplace preference data, and at least one of the first and second sets of review data.

9. The system of claim 8, wherein the software instructions, when executed by the one or more processors, further cause the one or more processors to:
present, via the first user interface, the modified review form associated with the candidate; and
receive, via the first user interface, a third set of review data corresponding to the candidate and the modified review form; and
wherein assigning the candidate to the first team is further based at least in part on the third set of review data.

10. The system of claim 8, wherein the software instructions, when executed by the one or more processors, further cause the one or more processors to:
further modify the modified review form based at least in part on the second set of review data;
present, via the first user interface, the twice modified first review form; and
receive, via the first user interface, a third set of review data corresponding to the candidate and the twice modified review form; and
wherein assigning the candidate to the first team is further based at least in part on the third set of review data.

11. The system of claim 8, wherein modifying the review form comprises at least one of removing a question, adding a question, replacing a question, modifying a question, and pre-filling an answer of the review form based at least in part on the first set of review data.

12. The system of claim 8, wherein the first set of review data composes an at least partially completed review form, and wherein the software instructions, when executed by the one or more processors, further cause the one or more processors to:
modify the at least partially completed first review form based at least in part on the first set of review data to at least one of:
remove a question;
add a question;
clear an answer;
modify an answer;
replace a question; and
modify a question;
present, via the first user interface, the modified at least partially completed review form.

13. The system of claim 12, wherein the software instructions, when executed by the one or more processors, further cause the one or more processors to:
receive, via the first user interface, a third set of review data corresponding to the candidate and the modified at least partially completed review form;
calculate a first score of the candidate based at least in part on the first set of review data, the second set of review data, and the third set of review data;
modify a candidate profile corresponding to the candidate based at least in part on the first score;
cause a notification to be sent regarding at least one of the first score and the modified candidate profile; and
present, via at least one of the first user interface, the second user interface, and a third user interface, at least one of the first score and the modified candidate profile.

14. The system of claim 8, further comprising one or more databases storing candidate profiles including a first candidate profile comprising workplace preference data corresponding to the candidate, wherein the software instructions, when executed by the one or more processors, further cause the one or more processors to:
calculate a first score of the candidate based at least in part on the first set of review data and the second set of review data;
modify the first candidate profile corresponding to the candidate based at least in part on the first score;
cause a notification to be sent regarding at least one of the first score and the modified first candidate profile; and
present, via at least one of the first user interface, the second user interface, and a third user interface, at least one of the first score and the modified first candidate profile.

15. The system of claim 8, wherein the software instructions, when executed by the one or more processors, further cause the one or more processors to:
receive, via at least one of the first user interface, the second user interface, and a third user interface, a third set of review data corresponding to the candidate and the review form and a fourth set of review data corresponding to the candidate and the review form; and
wherein modifying the review form is further based at least in part on a third set of review data and the fourth set of review data.

16. The system of claim 8, wherein the first set of review data corresponds to a first reviewer's review of the candidate, wherein the first reviewer belongs to a first category of reviewers, wherein the second set of review data corresponds to a second reviewer's review, wherein the second reviewer belongs to a second category of reviewers different from the first reviewer, and wherein the software instructions further cause the one or more processors to:
assign a first weight to a first score corresponding to the candidate and the first set of review data based at least in part on at least one of a number of modifications made to the review form based at least in part on the first set of review data, a seniority of the first reviewer, a score associated with the first reviewer, and a number of reviews received from the first category of reviewers;
assign a second weight to a second score corresponding to the candidate and the second set of review data based at least in part on at least one of a number of modifications made to the second review form based at least in part on the second set of review data, a seniority of the second reviewer, a score associated with the second reviewer, and a number of reviews received from the second category of reviewers;
assign an overall score to the candidate based at least in part on the first score, the first weight, the second score and the second weight; and
modify a candidate profile associated with the candidate based at least in part on the overall score.

17. The system of claim 8, further comprising one or more databases storing candidate profiles, candidate questions, candidate answers, and at least one of attributes and skills corresponding to each candidate answer of the candidate answers, wherein obtaining the workplace preference data comprises:
presenting, via a candidate interface, a set of candidate questions from the one or more databases to a candidate;
receiving, via the candidate interface, a set of candidate answers responding to a set of candidate questions; and
determining a set of attributes of the candidate based at least in part on the candidate answers and a query of the one or more databases; and
determining the workplace preference data of the candidate based at least in part on the set of attributes.
